(19) United States
(12) Patent Application Publication
(10) Pub. No.: US 2004/0175174 A1
(43) Pub. Date: Sep. 9, 2004

(54) Method and apparatus for ultrafast serial-to-parallel conversion and analog sampling

(76) Inventor: Avraham Suhami, San Jose, CA (US)

Correspondence Address: AURAHAM SUHAMI, 465 WILLOW GLEN WAY STE 325, SAN JOSE, CA, 95125, US

(21) Appl. No.: 10/760,692

(22) Filed: Jan. 20, 2004

Related U.S. Application Data
(60) Provisional application No. 60/441,286, filed on Jan. 21, 2003.

(51) Int. Cl. H04B 14/00

(52) U.S. Cl. 398/43

(57) ABSTRACT

When sampled simultaneously by a set of synchronized high intensity beams, a device consisting of a sequence of interlinked Nonlinear Sampling-Gates, through which a signal beam propagates, generates a replica of the intensity of the signal beam, during the interaction period. The device may be implemented optically or electrically as an ultra-high speed parallel receiver and when sampled by a femtolaser may be used to read a data train in parallel and thus at almost in real time. The device may also be used to stretch, compress, multiplex, demultiplex, read headers and help switch data trains optically in communication networks.

### PRIORITY INFORMATION

This application claims priority from provisional applications Ser. No 60/441,286 filed on Jan. 21, 2003, which is incorporated herein by reference in its entirety.

### FIELD OF THE INVENTION

This invention relates to ultrafast serial-to-parallel, analog-to-digital, conversion, receivers, transceivers, data train compressors and stretchers in the electrical and optical domains and optical communications.

Relevant Patents:

U.S. Pat. No. 6,633,696 Resonant optical wave power control devices and methods by Vahala, et al.

U.S. Pat. No. 6,631,236 Photonic crystal waveguide and directional coupler using the same by Yamada, Hirohito

U.S. Pat. No. 6,546,027 Laser saturable absorber and passive negative feedback elements, and method of producing energy output therefrom by Khaydarov

U.S. Pat. No. 6,571,035 B1 Fiber Optical switches based on optical evanescent coupling between two fibers” by Pi et al.

U.S. Pat. No. 6,411,752 Vertically coupled optical resonator devices over a cross-grid waveguide architecture by Little et al.

U.S. Pat. No. 6,396,617 “Photonic band gap device and method using a periodicity defect region doped with a gain medium to increase photonic signal delay” by Scalora, Michael

U.S. Pat. No. 6,369,937 Serial data to parallel data converter, Verber, et al.

U.S. Pat. No. 6,327,399 Optical devices employing an optical thresholder Fields et al.

U.S. Pat. No. 6,310,999 Directional coupler and method using polymer material Marcuse, et al.

U.S. Pat. No. 6,298,180 Photon transistors, by Ho

U.S. Pat. No. 6,289,027 Fiber optic lasers employing fiber optic amplifiers by Lawrence, et al.

U.S. Pat. No. 6,285,473 Polarization control optical space switch, Nishi et al.

U.S. Pat. No. 6,267,913 Two-photon or higher-order absorbing optical materials and methods of use by Marder et al

U.S. Pat. No. 6,266,145 Apparatus for measurement of an optical pulse shape, Lee et al

U.S. Pat. No. 6,262,414 Optical probe by Mitsuhashi; Yoshinobu

U.S. Pat. No. 6,252,892 Resonant fabry-perot semiconductor saturable absorbers and two photon absorption power limiters, Jiang et al

U.S. Pat. No. 6,233,378 Optical switch utilizing two unidirectional waveguide couplers by Sun De-Gui

U.S. Pat. No. 6,229,934B 1 High-speed low-loss fiber-optic switches Melman, et al

U.S. Pat. No. 6,226,112 Optical time-division-multiplex system, Derik et al.

U.S. Pat. No. 6,222,673 Group-delay-dispersive multilayer-mirror structures and method for designing same by Austin et al

U.S. Pat. No. 6,215,805 Q-switched semiconductor laser Sartorius et al.

U.S. Pat. No. 6,208,792 Article comprising a planar optical waveguide with optically nonlinear core Hwang et al.

U.S. Pat. No. 6,169,625 Saturable absorption type optical switch and controlling method therefor, Watanabe et al.

U.S. Pat. No. 6,163,391 Method and apparatus for holographic data storage by Curtis et al.

U.S. Pat. No. 6,160,656 Method and apparatus for optical correlation recognition by time-integrated nonlinear detection by Mossberg et al

U.S. Pat. No. 6,160,504 Repetitive absorptive thresholding optical quantizer, Fields et al.

U.S. Pat. No. 6,128,113 Transparent optical communications switch by K. DeMartino

U.S. Pat. No. 6,122,306 Self-pulsing multi-section laser Sartorius et al.

U.S. Pat. No. 6,108,474 Optical pulse compressor for optical communications systems by Eggleton, et al

U.S. Pat. No. 6,091,536 Optical processing device, Usami et al

U.S. Pat. No. 6,081,634 All-fiber optically-controlled Optical switch by Attard A.

U.S. Pat. No. 6,052,393 “Broadband Sagnac Raman amplifiers and cascade lasers” by Islam M. N.

U.S. Pat. No. 6,052,495 “Resonator modulators and wavelength routing switches by Little et al

U.S. Pat. No. 6,047,095 In-line polymeric construct for modulators, filters, switches and other electro-optic devices by Knoesen , et al.

U.S. Pat. No. 6,026,205 Compound optical waveguide and filter applications thereof by McCallion, et al.

U.S. Pat. No. 5,978,401 Monolithic vertical cavity surface emitting laser and resonant cavity photodetector transceiver by Morgan et al

U.S. Pat. No. 5,978,125 Compact programmable photonic variable delay devices by S. X. Yao

U.S. Pat. No. 5,970,186 Hybrid digital electro-optic switch by Kenney, et al.

U.S. Pat. No. 5,960,016 Aberration-Free, All-Reflective Laser Pulse Stretcher. by Perry M. et al.

U.S. Pat. No. 5,917,627 Optical TDM transmission system King, J. P.

U.S. Pat. No. 5,878,070 “Photonic Wire Microcavity Light Emitting Devices” by Ho et al.

U.S. Pat. No. 5,862,276 Planar microphotonic circuits by Karras

U.S. Pat. No. 5,841,560 System for optical pulse train compression and packet generation by P. Prucnal

U.S. Pat. No. 5,831,731 Apparatus and method for comparing optical bits Hall et al

U.S. Pat. No. 5,748,653 Vertical cavity surface emitting lasers with optical gain control (V-logic) Parker, et al.

U.S. Pat. No. 5,748,359 Infrared/optical imaging techniques using anisotropically strained doped quantum well structures by Shen et al.

U.S. Pat. No. 5,734,503 Dispersive dielectric mirror by Szipocs et al.

U.S. Pat. No. 5,654,812 Light-receiving device, optoelectronic transmission apparatus, and optical demultiplexing method, by Suzuki Nobuo

U.S. Pat. No. 5,642,453 Enhancing the nonlinearity of an optical waveguide Margulis, et al

U.S. Pat. No. 5,574,738 Multi-gigahertz frequency-modulated vertical-cavity surface emitting laser by Morgan et al.

U.S. Pat. No. 5,574,586 Simultaneous optical compression and decompression apparatus by Chu et al.

U.S. Pat. No. 5,535,032 Optical parallel-serial converter and optical serial-parallel converter by Bottle D.

U.S. Pat. No. 5,528,389 Optical holographic system for parallel to serial and serial to parallel conversion of optical data by M. Nuss

U.S. Pat. No. 5,477,382 Optical correlator system by B. Pernick

U.S. Pat. No. 5.459,801 Coupler used to fabricate add-drop devices, dispersion compensators, amplifiers, oscillators, superluminescent devices, and communications systems by Snitzer E.

U.S. Pat. No. 5,450,225 Optical switch for fast cell-switching network by Bostica et al.

U.S. Pat. No. 5,381.250, Electro-optical switch with 4 port modules with electro-optic polarization rotators, Meadows et al.

U.S. Pat. No. 5,349,591 Laser pulse stretcher and compressing with single parameter tunability, Weston et al.

U.S. Pat. No. 5,343,490 Whispering mode micro-resonator, McCall S.

U.S. Pat. No. 5,121,240 Optical packet time compression and expansion by A. Acampora

U.S. Pat. No. 5,172,258 Method and apparatus for high data rate fiber optic communication system, Verber C.

U.S. Pat. No. 5,099,147 Raman converter with variable wavelength distribution, Gregor, et al.

U.S. Pat. No. 5,032,010 Optical serial-to-optical converter, Shing-Fong Su

U.S. Pat. No. 5,030,929 Compact waveguide converter apparatus, by Moeller C.

U.S. Pat. No. 4,971,417 Radiation-hardened optical repeater, Krinsky, et al.

U.S. Pat. No. 4,737,007 Narrow-band wavelength selective optical coupler by R. Alfemess et al

U.S. Pat. No. 4,472,053 Method and apparatus for measuring the duration of optical radiation pulses by Wyatt et al

U.S. Pat. No. 4,136,929 Apparatus for generating light pulse train Suzaki Yasuzi

### Other Publications

Vander Lugt, “Signal detection by complex spatial filtering”, IEEE Trans. Inf. Theory IT-10, 139, 1964.

W. H. Glenn Theory of the two Photon absorption fluorescence method of pulsewidth measurement, IEEE J.QE-6 p.510-515 (1970)

Hashimoto, Optical Noise Reduction by a semiconductor waveguide Saturable Absorber, Technical Digest of CPT '98 in Cooperation with IEICE Electronics Society & EEE LEOS & OSA, pp. 215-216.

Reid et al., “Commercial Semiconductor Devices for Two Photon Absorption Autocorrelation of Ultrashort Light Pulses.” Optics and Photonics News. vol. 9. 1998.

E. Donkor “Low-power Fiber-based all optical switching” LEOS newsletter, april, 1999

Piccinin et al. All-optical recognition device for telecommunication signals in SPIE October 2000

E. W. Van Strvland. M. A. Woodall. H. Vanherzeele, and M. J. Soileau, “Energy band-gap dependence of two-photon absorption,” Opt. Lett., 10, 490, 1985.

E. W. Van Stryland, H. Vanherzeele, M. A. Woodall, M. J. Soileau, A. Smirl, S. Guha, and T. F. Boggess. “Two photon absorption. nonlinear refraction and optical limiting in semiconductors”. Opt. Engin., vol. 24, 613, 1985.

“Waveguide fabrication in nonlinear semiconductor doped glasses”, Ironside, C. N. et al. in Proceedings of the 11^{th} European conference on Optical Communications 1985, pp 237-240

C.Xu and W. W. Webb ” Measurement of two-photon excitation cross sections of molecular fluorophores with data from 690 1050 nm” Journal of Optical Society of America B13, 481-491, 1996.

Yue Hu et al. “Dendrimers facilitate Two-Photon Absorption applications”, Optics letters, Jul. 15, 2001

Petr Malý et al “Photoexcited carrier dynamics in CdSSe nanocrystals in glass -UFN report- Prague, Sartorius Bemd, “Photons under Control: Optical Signal Processing for High Speed Networks” in European Information Society Technologies 2000 event Jinno, M., et al., “Ultrafast all-optical logic operations in a nonlinear Sagnac interferometer with two control beams” vol. 16, No. 4 Optics Letters, Feb. 15, 1991 pp. 220-222.

S. G. Lipson et al. “Optical Physics” Cambridge University Press 1995

D. Marcuse, “Theory of Dielectric Waveguides,” Academic Press 1991

A. Yariv, “Optical Electronics,” Saunders College Publishing, 1991

“All-Optical Waveguide Switching”, G. I. Stegeman, E. M. Wright, Optical and Quantum Electronics 22 (1990), pp. 95-122.

“Optical time-division demultiplexing with resonant-cavity-enhanced surface-emitted second-harmonic generation,” T. G. Ulmer, et al. 1999 Annual Meeting of the Optical Society of America, 1999.

“Fundamentals of Optical waveguides” by Katsunari Okamoto, Academic press, 2000

“Waveguide fabrication in nonlinear semiconductor doped glasses”, Ironside, C. N. et al. in Proceedings of the 11^{th} European conference on, Optical Communications 1985, pp 237-240

“Design of Highly-Nonlinear Tellurite Fibers with Zero Dispersion Near 1550 nm”

Eric S. Hu, Yu-Li Hsueh, Michel E. Marhic, and Leonid G. Kazovsky; Optical Communications Research Laboratory(OCRL), Department of Electrical Engineering, Stanford University

“High transmission through sharp bends in photonic crystal waveguides,” A. Mekis, J. C. Chen, I. Kurland, S. Fan, P. R. Villeneuve, and J. D. Joannopoulos, Phys. Rev. Lett. 77, 87-3790 (1996).

“Waveguide branches in photonic crystals,” S. Fan, S. G. Johnson, J. D. Joannopoulos, C. Manolatou, and H. A. Haus, J. Opt. Soc. Am. B 18, 960-963 (1998).

“Photonic-crystal slow-light enhancement of nonlinear phase sensitivity” Soljac [symbol] ic et al. J. Opt. Soc. Am. B/Vol. 19, No. 9/September 2002

“Coupled resonator optical waveguide: a proposal and analysis,” A. Yariv, Y. Xu, R. K. Lee, and A. Scherer, Opt. Lett. 24, 711-713 (1999).

“Second-harmonic generation with pulses in a coupled-resonator optical waveguide,” S. Mookherjea and A. Yariv Phys. Rev. E 65, 026607(1-8) (2002).

“Microring coupled-resonator optical waveguides” Poon et al. Optical Society of America 2003

“Dispersion characteristics of photonic crystal coupled resonator optical waveguides” Woo Jun Kim et al., Optical Society of America 2003, December 2003/Vol. 11, No. 25/OPTICS EXPRESS 3431.

“Stopping Light All-Optically” Yanik et al. Phys. Rev. Letters Sep. 2003

“Block-iterative frequency-domain methods for Maxwell's equations in a planewave basis,” Steven G. Johnson and J. D. Joannopoulos, Optics Express 8, no. 3, 173-190 (2001),

“Ultrafast response (˜2.2 ps) of ion-irradiated InGaAs photoconductive switch at 1.55 μm”

Mangeney et al., Applied Physics Letters Vol 83(26) pp. 5551-5553. Dec. 29, 2003

Optical Header Recognition Using Fiber Bragg Grating Correlators by McGeehan et al. CLEOS 2002

### BACKGROUND OF THE INVENTION

Data embedded in electromagnetic waves, whether broadcast in free space, communicated via transmission lines or fiber optics, is generally encoded serially. Communication receivers read and decode incoming data, as they arrive, one bit at a time. Thus reading a 32-bit word in a 40 GHz optical communication network will take 32×25 psec=800 psec. Obviously reading all the 32-bits in parallel, within the time it takes to read one bit, within 25 psec is desirable as it allows the subsequent data processing to start earlier.

U.S. Pat. No. 5,535,032 “Optical parallel-serial converter and optical serial-parallel converter” by D. Bottle teaches a serial-to-parallel converter for demultiplexing synchronized streams of data in an interleaved OTDM system, by attaching to the waveguide transporting the serial optical stream, switchable taps at sequential intervals, said switches properly synchronized to open and close so as to admit one bit each, out of the serial interleaved stream of data, during a frame at a repetition rate equal to the frame rate. The operation of the system is entirely dependent on the proper timing of the switchable elements which being electrical are relatively slow and is suitable only for synchronized systems, whose synchronicity is known in advance.

Time compression of data is an essential process that helps aggregate lower bandwidth data emanating from a multitude of end-users, in order to transmit such data through higher bandwidth channels and thus increase the density of data carried on any single channel. U.S. Pat. No. 5,121,240, Optical packet time compression and expansion by A. Acampora teaches a method of compression and decompression of pulses by circulating them on a circle and switching and diverting at the appropriate time, one pulse after another to another channel. Similarly U.S. Pat. No. 5,841,560 System for optical pulse train compression and packet generation by P. Prucnal teaches a method to compress a packet in the time domain by passing the data packet through a sequence of switchable delays of increased length. In both cases it is the speed of the switching elements that determines the speed of compression, in adition to the complexity of the switching elements.

SGH (Second Generation Harmonics), TPA (Two Photon Absorption), TPF (Two Photon Fluorescence) and SRS (Stimulated Raman Scattering) based optical amplification, are among the fastest interactions of light with matter, occuring in the subpicosecond and the femtosecond time domain. Thus they naturally constitute the building blocks of ultrafast switching devices.

Several patents, U.S. Pat. No. 5,032,010 “Optical serial-to-parallel converter” by Shing-Fong Su, U.S. Pat. No. 5,172,258 “Method and apparatus for high data rate fiber optic communication system” by Carl Veber, U.S. Pat. No. 6,226,112 “Optical time-division-multiplex system” by Denk, et al., U.S. Pat. No. 6,369,937 “Serial data to parallel data converter” by Verber et al. teach how to demultiplex a Time Division Multiplexed optical train propagating in a waveguide by counter propagating from the opposite direction another optical train of lower frequency and detecting the frequency of the peaks of the superposition of the two trains by detecting the Two Photon interaction between the beams, with photodiodes sensitive to the sum of the energies of the peaks, deposited on top of the waveguide. All these devices have low sensitivity given the limited time and space of the interaction.

U.S. Pat. No. 6,052,393 “Broadband Sagnac Raman amplifiers and cascade lasers” by M. N Islam. teaches how to build a polarization independent broadband Raman amplifier. Optical Raman amplification consists in excitation of molecular vibrational states of the medium in which the signal beam propagates, by an intense higher energy (lower wavelength) beam, denoted as the “pump”, that imparts part of its energy to the signal beam. The signal amplification is due to third order nonlinear interaction with the Raman-active material, and is proportional to the intensity of the light passing through the medium. The lifetime of the molecular vibrational states of the Raman-active material being extremely short, the amplification is instantaneous for all practical purposes. Raman amplifiers can be pumped at any wavelength as the molecular vibrational states are almost in a continuum; thus cascading Raman amplifiers in steps allows to down-convert from a lower to a higher wavelength in several steps. One important characteristic of Raman amplification is that the new Raman photon stimulated by the vibration of the medium has the same direction and polarization as the stimulating photon and the amplification is maximized when the pumping beam has the same direction and polarization as the stimulating seed photons.

U.S. Pat. No. 4,971,417 Radiation hardened optical repeater by Krinski et al teaches the use of a nonlinear optical thresholding saturable absorber, such as poly-di-acetylene that transmits light only when the light falling on it exceeds a predetermined threshold.

U.S. Pat. No. 6,169,625 Saturable absorption type optical switch and controlling method therefor, by Watanabe et al. teaches how to control an optical switch using saturable absorption media such as poly-di-acetylene. The low intensity signal absorbed in the saturable absorption type optical element, is transmitted when a high intensity control lightwave pulse turns the saturable absorption type optical element, to transmission mode.

U.S. Pat. No. 5,748,359 “Infrared/optical imaging techniques using anisotropically strained doped quantum well structures” by Shen, et al. teaches how to rotate the polarization of a light beam with a second IR beam. The polarization rotator is formed from a Multiple Quantum Well (MQW) structure grown on a semiconductor substrate with a thermally induced, uniaxial, in-plane, compressive strain. The MQW structure includes a heterostructure of undoped barrier layers and doped quantum well layers. The strain causes the quantum well layers to have anisotropic radiation absorption characteristics. In particular, orthogonal components of light parallel to and perpendicular to the strain will experience different degrees of absorption. The dopant in the quantum well layers is sufficient to bleach the lowest exciton resonances, thereby reducing absorption of the light beam. IR absorption decreases the bleaching and increases the ability of the quantum well layers to promote exciton transitions. As such, the ratio of the intensities of the respective polarization states of the light beam changes as a function of the amount of IR absorbed.

Petr Malý et al in “Photoexcited carrier dynamics in CdSₓSel₁₋ₓ nanocrystals in glass” have shown that CdSₓSe₁₋ₓ nanocrystals embedded in glass can act as an ultrafast Kerr cell and can rotate the polarization of a linearly polarized NIR beam, when irradiated with a second linearly polarized high intensity beam. The relaxation times are in the range of 100 fs.

E. Donkor in “Low-power Fiber-based all optical switching” in a university of connecticut newsletter has reported on the shift in the stop band of a grating inscribed in a CdSSe doped silica fiber, when irradiated by a pumping light beam.

There are numerous descriptions in the literature of fiber optic switches based on the nonlinearity of the refractive index of one of the fibers, of a coupled pair of fibers. Changing the coupling length between the fibers by changing electrically or optically the propagation constant of light in one of the fibers, causes the popagating light wave to switch from one fiber to another.

U.S. Pat. No. 5,642,453 “Enhancing the nonlinearity of an optical waveguide” by Margulis, et al. discloses a waveguide combined with a closely adjacent highly nonlinear film preferably of a semiconductor material. The evanescent field of light propagating along the waveguide extends up to the film; thus the large nonlinear properties of the film influence the optical characteristics of the waveguide. When positioned along a similar D-fiber, the device can be used as a fiber-based, nonlinear coupler controlled by a relatively weak light signal.

U.S. Pat. No. 5,978,401 Monolithic vertical cavity surface emitting laser and resonant cavity photodetector transceiver by Morgan et al describes a combination of a photodetector and laser diode in one package

“U.S. Pat. No. 6,310,999 Directional coupler and method using polymer material” by Marcuse, et al. describes a method of switching a lightwave from one waveguide to another by changing the index of refraction of a polymer film placed between the waveguides, by heating the film.

### SUMMARY OF THE INVENTION

It is the purpose of this invention to introduce a new optical device, that can be used in its various forms and modifications, for reading the data in a train of digital pulses in parallel, optically or electronically, for sampling an analog signal as a precursor for digitizing said samples, for compressing in the time domain pulses and data trains, and for demultiplexing interleaved serial streams of data into parallel optical or electronic trains, at petaherz rates, practically in real time.

We define “2 input −2 output gates” based on the nonlinear interaction of the 2 inputs determining the nature and intensity of the 2 outputs, as Nonlinear Sampling-Gates hereinafter referred to as S-Gates. The devices of the invention, constitute sequences of interlinked juxtaposed S-Gates, based on the above mentioned nonlinear effects where the signal to be sampled propagates from one S-Gate to the next, largely unperturbed, in the absence of a second input, a high intensity light source. When a high intensity beam is applied to one, several or all the interlinked S-Gates simultaneously for a given short time period, they will generate simultaneously, at their outputs a signal resulting from the interaction of the beams during said time interval. The sampling high intensity beams may be high power VCSELs activated synchronously and simultaneously or a laser pulse split into N branches, each branch properly delayed so as to trigger the relevant S-Gates simultaneously.

A sequence of (n) interlinked S-Gates when gated simultaneously and synchronously by a fast optical beam at a repetition rate (fₛ), constitutes a serial-to-parallel converter for a signal of frequency F=nfₛ. If the gated signal is analog and the S-Gate preserves the amplitude of the sampled portion, the sequence of (n) interlinked S-Gates may be used as an ultrafast parallel sampler, where each sample may be digitized by a slower analog-to-digital converter.

The interlinked juxtaposed array of S-Gates may be implemented in several forms and technologies.

The various embodiments of the invention are based on several well known nonlinear effects that arise when high intensity light waves interact in spatio-temporal coincidence within certain materials and configurations that exhibit the nonlinear effects. These effects include, but are not limited to, TPA (Two Photon Absorption), TPF (Two-Photon Fluorescence), SRS (Stimulated Raman Scattering), Nonlinear Refractive Index, Saturated Absorption, Nonlinear switching in evanescent wave coupled fibers and Photonic Crystals. The materials include nonlinear crystals, amorphous materials, optical fibers and photonic crystals. Thus a signal beam, modulated to encode a data stream, when interacting with an intense sampling beam, will generate under favorable conditions, instantaneously, a frequency-sum beam modulated as the signal beam.

In a Raman active medium, the signal beam may be amplified several orders of magnitude by an intense second beam interacting with it.

In another embodiment the signal beam propagating in a nonlinear specialty fiber will change its propagation time in the presence of a co-temporal second high intensity beam that changes appreciably the refraction index of the fiber and thus will change its phase in a given path length. In still another embodiment the reflective bandwidth of a dielectric mirror composed of a multiplicity of alternating layers of materials having different refractive indexes, will change in the presence of a high intensity beam that changes the refractive index of one of the materials and consequently may transmit a lightwave that previously was reflected.

Another nonlinear effect, that may be used to implement the invention, is the optical absorption saturation effect of a semiconductor, where its absorption decreases and its transmittance increases, as the intensity of the sampling beam having an energy near a band edge, greatly increases. As the band gap of a semiconductor can be structured by selecting the relative proportions of its constituents, the threshold wavelength of switching from absorption to transmittance can also be structured. Saturable absorbers with different thresholds may also be implemented by quantum well (QW) structures. Normally, the weak signal beam will not pass through the saturable absorber due to the large absorption; however, when the high intensity sampling beam causes saturation of the saturable absorption element, the transmittance suddenly increases and permits the signal beam to pass through. Given the Kramers-Kronig relation between the change of the refractive index and the change of the absorption spectrum, saturable absorption elements can be used as optical gates as the refractive index of a saturable absorption element will vary in response to the intensity of the incident light that will change the absorption spectrum of the saturable absorber. The creation of electron-hole pairs leading to absorption saturation and the shift to the transmittance mode is a rapid process of the order of picoseconds, however the recombination of the carriers is a longer process that impends the quick return to an absorption mode. However the carrier recombination process can be accelerated by irradiating the saturable absorbing element with low energy photons (IR beam) that cause induced emission leading to acceleration of the radiative recombination. Thus both rise and fall times of the order of picoseconds of the signal pulse can be replicated at the output of the saturable absorption element. Single Walled Carbon Nanotubes (SWCN) composites have been shown to switch from absortive to transparent in less than 1 psec when irradiated with 1550 nm femtosecond pulses and can thus be used as ultrafast saturable absorbers and switches.

Photonic crystals are one, two or three dimensional periodic composite media, alternating in their refractive index. The above mentioned dielectric mirror constitutes a one-dimensional Photonic crystal. In particular, square, triangular and honeycomb lattices have adequate electromagnetic properties. Due to the diffraction of the electromagnetic waves propagating in such media, Photonic Crystals exhibit rejection bands which specifically forbid propagation of some frequencies in certain directions. By appropriately chosing the appropriate geometry, size and refractive index of the constituent materials, structures may be built that exhibit desired patterns of transmission, or bands of forbidden frequencies. A “defect” or “cavity” having different electromagnetic propagation features may be introduced into the Photonic Crystal, by appropriately changing the size, the refractive index or both, of an element of the Photonic Crystal lattice. A cavity when isolated supports a resonant mode with a frequency inside the bandgap. Cavities store energy at resonant frequencies; by varying the defect size the cavity resonance can be tuned to any frequency in the bandgap. Several closely packed cavities form a linear defect; photons propagate from one cavity to the next by tunneling and consequently at a lower group velocity which declines with the coupling strength of the cavities. Thus group velocities of 10⁻³ c or even smaller are attainable. Lines of interconnected cavities may serve as directional waveguides of certain frequencies. Resonant Cavities may serve as bridges between nearby waveguides; transfer between two nearby waveguides occurs when the system modes have the same frequency of the resonator(s) and the same decay rate.

Thus electromagnetic waves of certain frequencies may be transfered (add/drop), switched from one waveguide to another or their propagation direction may be changed abruptly, by a wide angle.

Several Resonators may be tightly or loosely connected by adjusting their respective distances, sizes and refractive index. Such appropriately Coupled Resonator Optical Waveguides (CROW) enable control of the group velocity and positive/negative dispersion and thus can be used as delay lines with minimal dispersion.

Photonic Crystal design tools are available commercially, for example from Photon Design ltd. (www.photond.com). A software program for computing the band structures (dispersion relations) and electromagnetic modes of periodic dielectric structures (the MIT Photonic-Bands MPB) is freely available for download from the ab-initio.mit.edu/mvb/ website.

Deep UV lithography used in semiconductor manufacturing, may be used to manufacture Photonic crystal devices.

One form is like a modified Fabry-Perot etalon, a sequence of S-Gates formed by two well polished parallel plates coated with multilayers of dielectric mirrors. The signal beam, travels between the plates reflected sequentially from one mirror to another. One of the plates may have under the dielectric mirror coating, several nonlinear materials, such as Raman active media, SGH media, Two Photon Absorbers, Polarization rotators and Saturated Absorbers, followed by interference filters and Polarization analyzers. Each reflection spot at this plate constitutes an S-Gate. The signal beam may be reflected or transmitted depending on an interaction with a sampling beam, that changes the wavelength of the stop band of the dielectric mirror. If transmitted the signal beam will interact with the co-linear sampling beam coming from the same direction, within the underlying nonlinear media, thus generating a resultant beam depending on the nature of the nonlinear material, the energy and intensity of the sampling beam. The underneath interference filter will suppress the sampling beam and let pass the resultant beam. In certain versions the sampling beam may come from the opposite direction to the signal beam, traversing first the substrate upon which the dielectric miror is deposited and interacting with the nonlinear dielectric mirror, immediately before the signal beam impinges on it.

In a second embodiment the two opposite plates are replaced by a transparent solid rectangular slab of material, transparent to the signal and sampling beams, such as glass. The well polished opposite faces are coated externally with multilayer dielectric mirrors. In the absence of a sampling beam, the signal propagates by total reflection from one mirrored face to the opposite one. In this version too one of the faces coated by a dielectric mirror may be overcoated with several nonlinear materials, such as Raman active media, SGH media, Two Photon Absorbers, polarization rotators and Saturated Absorbers, followed by interference filters and polarization analyzers. At the reflection point which constitutes the input of an S-Gate, the signal beam may be reflected or transmitted depending on the interaction with the sampling beam, that changes the wavelength of the stop band of the dielectric mirror. The sampling beam, in this version too, may either come from the same direction as the signal beam, traversing first the slab of glass before interacting with the dielectric mirror, or from the opposite direction to the signal beam beam, from outside the slab of glass. If the transmitted signal beam and the sampling beam are co-linear and come from the same direction, they will interact within the overlaying nonlinear media, thus generating a resultant beam depending on the nature of the nonlinear material and the sampling beam's energy and intensity. The overlay of interference filter will suppress the sampling beam and let pass the resultant beam. If the sampling beam comes from the opposite direction to the signal beam, it will first traverse the substrate upon which the dielectric miror is deposited and interact with the nonlinear dielectric mirror, immediately before the signal beam impinges on it.

In both versions, alternatively to shifting the wavelength of the stop band of the dielectric mirror, the reflectivity of the dielectric mirror may be slightly reduced, letting a small portion of the signal beam to be transmitted to the next layer of nonlinear material. In this case, the transmitted weak signal beam may interact with a substantially co-linear sampling beam, within a Raman active media underneath the dielectric mirror and be substantially amplified generating a resultant beam that replicates the modulation of the signal beam.

A third embodiment of the juxtaposed interlinked array of S-Gates may be implemented by a series of interlinked unsymetrical directional fiber couplers. As the nonlinear effects are intensity dependent, it is highly advantageous to focus or collimate the high intensity beam onto a small region of the order of microns where the interaction with the signal beam takes place, which makes a single mode specialty fibers doped with highly nonlinear materials the ideal medium for the effect. In normal operation the signal beam travels along the main fiber, unperturbed by the coupling of the evanescent wave onto the series of coupled fibers, the power returning into the main fiber, as long as no phase change occurs along the length of the coupler. Changing the phases of the evanescent waves coupled into the highly nonlinear secondary fibers by illuminating them simultaneously with high intensity sampling beams, will transfer part or the full power (if Δφ=π/2) onto the coupled secondary fiber for the time interval that the sampling beam persists. Thus if the couplers are positioned at intervals equal to the bit length of the data train propagating in the main fiber, each bit will be replicated at the corresponding coupler and the serial data train converted to a parallel set of pulses. As the coupled signal may have a low amplitude, the high intensity beam may be further utilized to amplify the evanescently coupled weak signal by the raman effect.

The method of sampling in parallel the intensity of an electromagnetic wave with a limited number of sampling gates is extensible to continual sampling of a long data train, by activating the limited number of sampling gates at a repetition rate commensurate with the speed of the network. The sampled data may then be aggregated in real time, to provide a continual optical reading of long data trains, without converting them to the electrical domain.

Another embodiment of the juxtaposed interlinked array of S-Gates, may be implemented with a successive series of switchable directional couplers implemented in Photonic Crystal waveguides.

The switching of the directional coupler embedded in a Photonic Crystal, is achieved by optical tuning of the resonant frequency of several coupled resonant cavities lying between the two waveguides, to the frequency of the system mode including the waveguides. Optical tuning is achieved by dynamically changing the refraction index of the elements of the resonant cavities. A great advantage of this implementation is that due to the high nonlinearity of resonant cavities, switching them on and off the resonant frequency, may be effected with an optical beam of moderate power. Also, the synchronization of sampling the S-Gates simultaneously, may be implemented within the same Photonic Crystal structure, by appropriately delaying the sampling signals using coupled resonant optical waveguides (CROWs).

This method of positioning a series of directional couplers along the “guide” of a propagating electromagnetic wave, for extracting a parallel replica of the wave, is applicable in principle to all wavelengths, from the optical domain down to microwaves and electrical domains, for waves propagating within a “transmission waveguide” in the larger context, whether along a conductor, a coaxial cable, a transmission line, optically in free space or within a fiber. The structure of the coupler in each case is obviously different, depending on the frequency of the waveform tapped.

These and other features and advantages of the present invention will be apparent to those skilled in the art, from the following detailed description, taken together with the accompanying drawings, in which like reference numerals refer to like parts.

### BRIEF DESCRIPTION OF THE DRAWINGS

FIG. 1 illustrates the logic of the “S-Gate”, which is the basic building block of the serial-to-parallel converter and is composed of an AND Gate followed by a XOR Gate,.

FIG. 2 shows the structure of the “Serial-to-Parallel Converter” that consists in a serially connected juxtaposed S-Gates through which propagates a data train and its use as a stretcher or compressor.

FIG. 3 illustrates the sampling of an analog signal propagating through the serially connected S-Gates and its use in constructing an ultrafast analog to digital converter.

FIG. 4 shows an embodiment of an S-Gate based on a multilayer dielectric mirror that turns transparent when illuminated with a high intensity beam of light propagating co-linearly with the signal beam.

FIG. 5 illustrates an improvement of the S-Gate illustrated in FIG. 3 by building the multilayer dielectric mirror upon a substrate of a saturable absorber.

FIG. 6 shows an alternative embodiment of the S-Gate illustrated in FIG. 4 where the high intensity sampling beam illuminates the multilayer switchable dielectric mirror, from a side direction orthogonal to the dielectric mirror.

FIG. 7 illustrates an S-Gate where the switchable dielectric mirror and interference filter are integrated with an Avalanche Photo Detector (APD) that detects the transmitted signal beam and a semiconductor laser generating the sampling beam that turns the switchable dielectric mirror from reflective to transparent.

FIG. 8 shows another embodiment of the S-Gate where the signal beam first traverses the dielectric mirror that has been turned transparent by a high intensity sampling beam and when both penetrate co-linearly into a Raman active material, they are amplified by Stimulated Raman Scattering (SRS).

FIG. 9 shows another embodiment of the S-Gate, where the high intensity sampling beam after switching the dielectric mirror from reflective to transparent, interacts with the signal beam in a Second Generation Harmonic (SGH) medium, thus generating a frequency sum beam.

FIG. 10 shows another embodiment of the S-Gate where the SGH medium described in FIG. 10 is replaced by a semiconductor P-I-N photodiode or LED having a bandgap energy smaller than the sum of the two interacting beams but is larger than the energy of the photons in either of them.

FIG. 11 illustrates a directional waveguide coupler embedded in a Photonic Crystal, with a resonant cavity between the two branches of the coupler, where the signal propagating in one waveguide may be switched to the second waveguide by changing the refractive index of the ‘defect” and therefore its resonant frequency.

FIG. 12 illustrates another embodiment of the S-Gate, where two waveguides structured in a Photonic crystal are coupled with a micro-ring made out of non-linear material, and transfer the signal from one waveguide to the other when the sampling beam illuminates the micro-ring.

FIG. 13 shows an alternative embodiment of the S-Gate in the form of a directional fiber coupler in which the signal beam propagating in one fiber is switched onto the evanescent wave coupled second fiber by a strong sampling beam that changes the phase of the coupled lightwave.

FIG. 14 shows an alternative embodiment of the S-Gate where the switching of the signal from one fiber to the second in a directional fiber coupler, is assisted by a third fiber placed in proximity to the second fiber or between the two and whose refraction index is strongly changed by a high intensity sampling beam, thus causing a strong interference on the initial balance of power transfer in the directional coupler and changing the amount of power transferred onto the second fiber.

FIG. 15 shows an alternative variation of the geometry of the directional fiber coupler based S-Gate, illustrated in FIG. 16 where the interference in the coupling between the fibers of the coupler is effected by a thin film having a large nonlinear coefficient, deposited on the second fiber whose index of refraction is strongly changed by a strong sampling beam and which is evanescently coupled to the signal carrying fiber.

FIG. 16 illustrates an alternative embodiment of the S-Gate where the switching of the signal from one fiber to a second fiber laying in an orthogonal direction above it, is effected by changing the refraction index of an evanescently coupled micro-ring situated between the fibers, by irradiating it with a moderate intensity sampling beam.

FIG. 17 illustrates the structure of a Raman Trigger whose timing accuracy is determined by an auxiliary low intensity signal.

FIG. 18 shows the structure of a fabry-perot like S-Gate array containing 32 S-Gates, similar to those described in connection with FIGS. 8, 9, 10 or 11 and built out of two parallel plates coated internally by dielectric mirrors, where the signal propagates from one gate to the next by reflection between the plates and is refocused between two reflections by GRIN lenses situated between the plates.

FIG. 19 illustrates an array of 32 S-Gates, similar to that described in connection with FIG. 7 and constructed out of a rectangular slab of transparent material whose top side is coated with a chirped mirror while its bottom is coated with an interference filter and a switchable dielectric mirror and where the sampling beam is directed to the switchable miror orthogonally, from the side.

FIG. 20 illustrates a receiver based on an array of S-Gates based on directional fiber couplers.

FIG. 21 illustrates a transceiver where the emitting light sources are distributed in parallel and evanescently coupled to the receiving directional couplers.

FIG. 22 illustrates an electrical serial-to-parallel converter composed of a sequence of electromagnetic S-Gates where part of the power transported in a transmission line or coaxial cable is tapped by an inductor wound around the transmission line.

FIG. 23 illustrates an ultrafast serial-to-parallel converter implemented in a Photonic Crystal using directional waveguides that may be critically coupled by optically changing the refractive index of connected resonant cavities.

FIG. 24 illustrates an ultrafast serial-to-parallel converter implemented in a Photonic Crystal using directional waveguides that may be critically coupled by optically changing the refractive index of micro-rings evanescently coupled with the waveguides.

FIG. 25 illustrates a compact ultrafast serial-to-parallel converter where the data propagating in an optical fiber is extracted simultaneously to a multiplicity of fibers lying above and orthogonal to it, critically coupled by micro-rings laying between the fibers and evanescently coupled to them.

FIG. 26 illustrates the time compressing of long data trains propagating in an optical fiber by using the ultrafast serial-to-parallel converters described in the invention.

FIG. 27 illustrates a decoding scheme that overcomes the timing sensitivity of sampling of the S-Gate arrays.

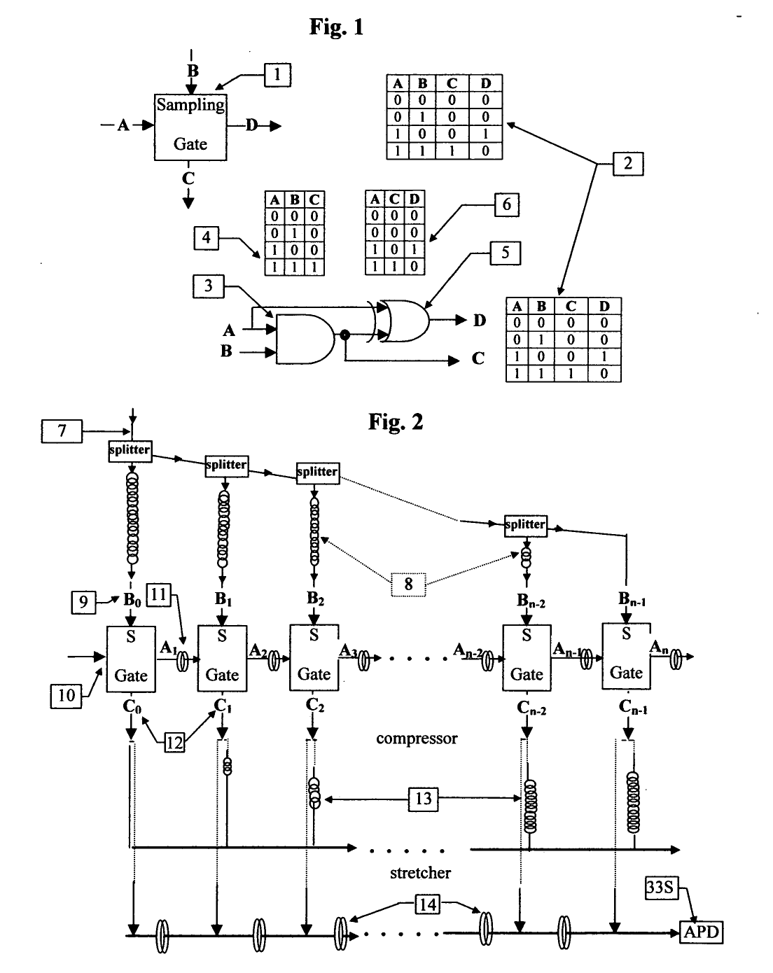

The (n) S-Gates (1 to n) if activated simultaneously by the sampling beams B₀ to Bₙ₋₁, will interact with the signal beam elements A₀ to Aₙ₋₁ concurrently, and will generate outputs C₀ to Cₙ₋₁ which will mirror the levels at A₀ to Aₙ₋₁. Thus if the “distance” between the gates equals the “bit” length of the data train, the serial data encoded on the signal beam will be read in parallel bit by bit and processed in parallel. If the temporal width of the sampling pulses are of “bit” length, the parallel outputs C will also be of the same width, provided of course that the interaction time between the signal A and the sampling beam B is significantly shorter. To ensure synchronous triggering of all the S-Gates simultaneously the sampling beams B₀ to Bₙ₋₁ may be derived from one source and consecutive sampling beams may be delayed by gradually decreasing delay lines 8, so that the delay difference between any two adjacent sampling beams equals the propagation time between the respective adjacent S-Gates. In case of a 10 GHZ communication network, the delay difference between two adjacent sampling beams would be 62.5 psec or 12.5 mm of silica fiber; thus for a 32 bit parallel reader, the sampling beam B₀ would be delayed by 38.75 cm of glass fiber while the Bₙ₋₁ beam would not be delayed at all.

The sequence of S-Gates arrays may be used as a temporal compressor of a packet of pulses, by first sampling the signal beam for a shorter period than the “bit” length, and delaying any sample relative to the previous one, by a delay equal to the time difference between the “bit” length and the sampling length and then recombining them in series. Thus for example in a 40 GHz communication network where the “bit” length is 25 psec, sampling the data train by 100 fs wide sample pulses, delaying each sample by (25 psec−0.1 psec=24.9 psec) 13 in respect to the previous one, and then combining all the samples in series, will compress the data train by a factor of 250. Thus for example a 32 bit word would be compressed from 800 psec to 3.2 psec and a packet header of 5 32 bit words would be compressed from 4 nsec to 16 psec. This compression of course presumes that “chopping” a “slice” (1/250) wide of the original pulse, leaves sufficient photons to distinguish it from noise. Thus it is advantageous to design an S-Gate in which the signal beam interacting with the sampling beam also undergoes an amplification.

Inserting delays Δt 14 between the (n) parallel samples and recombining them serially would achieve the opposite result of “stretching” the train length by nΔt. This strategy of stretching the train length is beneficial in case of a low repetition rate of fast pulse trains, as it allows using slower electronics for processing bursts of data.

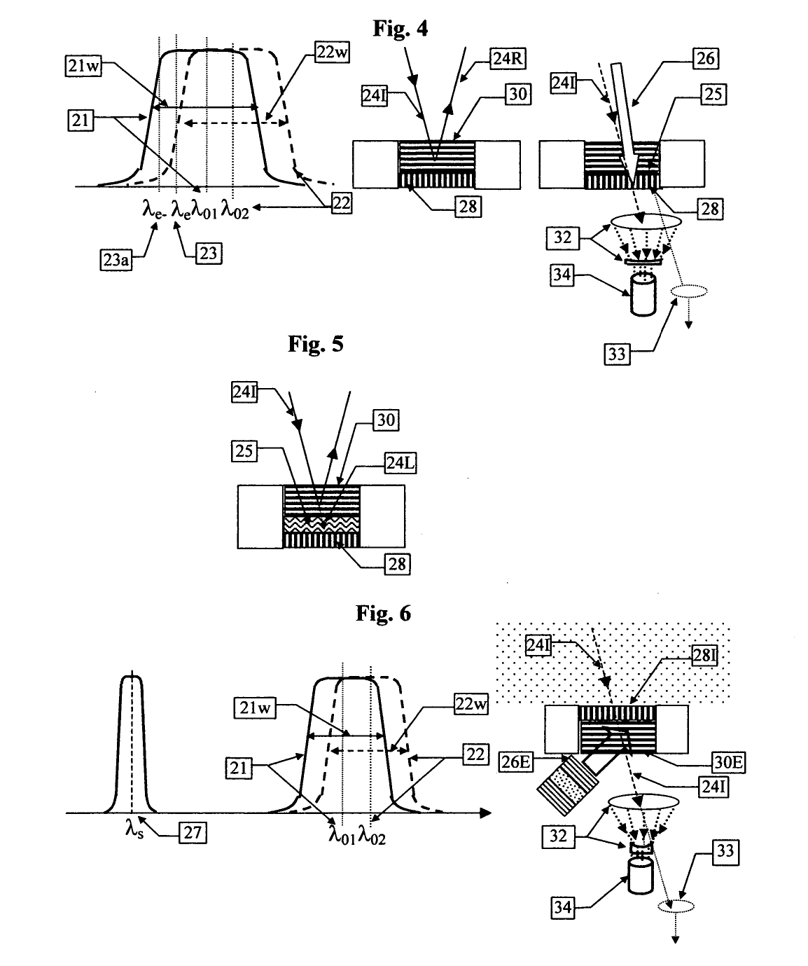

Converting a serially coded wave train, to parallel beams facilitates the data detection and conversion process. The photo diodes (33, FIG. 4), that detect the sampled pulses Cₙ, may operate at a much lower bandwidth depending on the repetion rate (f) of the sampling beam. In effect if the length of the S-Gate array accommodates N bits, the photodiodes (33, FIG. 4) will receive data at a rate (f/N). Thus Photo detectors with slower response (and lower cost) may be used to detect the sampled beam's level, integrating the fast sample pulse, but managing to recover before the next sampled pulse arrives. If the repetition rate is real slow, the delayed and serially combined optical pulses may be detected by a single photo detector 33S.

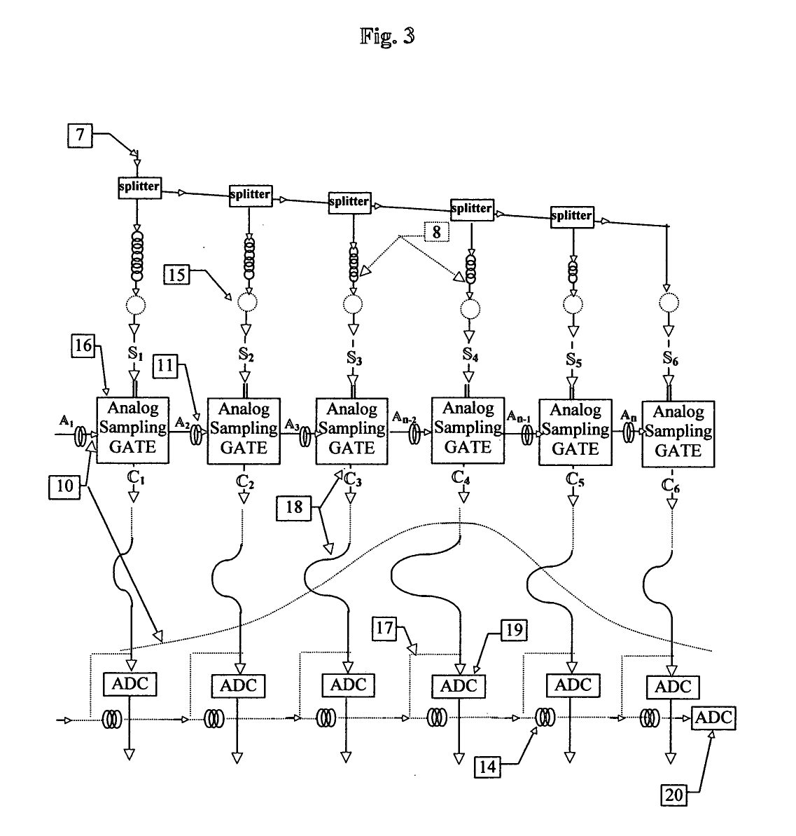

FIG. 3 illustrates the operation of Analog Sampling Gates 16 which differ from the digital S-Gates illustrated in FIG. 1 in that, the level of the sampled output 18 is proportional to the level of the signal beam 17, notwithstanding the fact whether the medium in which the interaction with the sampling beam takes place, is nonlinear or not. Adjacent Analog Sampling Gates 16 in an interlinked array are separated by delays 11, that combined with the internal propagation time in the Analog Sampling Gate, equal the width of the sampling beams Sᵢ (i=1 . . . n). Note that the sampling beams Sᵢ (i=1 . . . n) do not have to be of equal width; in fact there is an advantage to be able to sample an analog signal with narrower sampling signals, in regions of the analog pulse expected to be changing faster (for example during the rise time of a pulse) and reduce the sampling width in regions where the analog signal is not expected to change significantly (for example during the flat top of a pulse).

In case that the desired sampling width is uniform, the Sampling Analog Gates may be activated simultaneously by synchronized sampling signals Sᵢ, obtained by splitting a common sampling source 7 into (i) branches and delaying each branch with gradually decreasing (by the sampling width) delays 8. The common source 7 is triggered when the analog signal 10 is within the array, covered by the Analog Sampling Gates Aᵢ. Each Analog Sampling Gate generates an output analog signal Cᵢ during the time period it is activated by the sampling signal Sᵢ. Clearly, the temporal width of the sampling pulse determines the width of the sample; the level of the sampled pulse is proportional to the analog signal propagating within the gate during the sampling time. If the width of the sample equals the temporal distance between the gates and provided that the response time of the gates are as fast as the sampling signal, the sampling is exhaustive and the aggregate output of the samples faithfully represents the shape of the analog signal. The resultant parallel samples may be digitized by slow ADCs 19, their speed depending on the repetition rate of the analog signals. For example a 6.4 psec wide analog pulse recurring at 1 MHz repetition rate may be sampled by 64 Analog Sampling Gates when sampled by 100 fs wide femtosecond laser split into 64 samples, 100 fs wide each. Each sample may then be integrated and digitized separately by a relatively slow 100 MHz ADC. Alternatively, instead of using slow ADCs, delays T_{D} long 14, may be inserted between the Cᵢ (i=1 . . . n) outputs 18 of the adjacent Analog Sampling Gates and combined into one serial output, thus “stretching” the total output by (n)×T_{D}. The stretched signal may be “shaped” and then digitized by one slow ADC 20 having a bandwidth of ˜1/T_{D}.

FIG. 4 illustrates an S-Gate that can be implemented, by a multilayer dielectric mirror 30 deposited on top of an interference filter 28, using the fact that the stop band formed by the dielectric mirror can be appreciably shifted from λ₀₁ 21 to λ₀₂ 22, and while its width widened 21W or narrowed 22W by an illuminating high intensity sampling beam 26. The multilayer dielectric mirror may also be analyzed as a one dimensional Photonic crystal having a bandgap that fully reflects a range of frequencies, while the width of the bandgap may be changed by changing the refractive index of one or both constituents of the periodic array.

Thus a light beam 241 having a wavelength λₑ 23 that initially was within the stop band and as a result was fully reflected 24R, may after the multilayer dielectric mirror 30 is illuminated by a high intensity sampling beam 26, fall outside the stop band and therefore be transmitted. The interference filter 28 would stop the high intensity sampling beam 26 and let pass the signal beam 241. In the following narrative we shall denote such gates as “switchable mirror gates”. Note that “switchable mirror gates” can be implemented both as digital S-Gates if the output sampled signal is detected by a threshold detector or as an Analog Sampling Gate if the sampled signal is further linearly amplified and then digitized by an ADC.

Building high performance interference filters by depositing quarter wavelength thin layers of materials, with alternating indexes of refraction (n_{H} and n_{L}), is a well developed technology used widely for demultiplexing wavelengths in DWDM networks. Narrow bandwidths of a fraction of a nanometer and very steep walls are currently achieved. When the thicknesses of the alternate layers (d_{H}) and (d_{L}) and their respective refractive indexes (n_{H}) and (n_{L}) obey the equation d_{H}n_{H}=λ₀/4 the lightwave of λ₀ wavelength is fully reflected. The relative width of the stop band is given by (Δλ/λ₀)=(4/π)arcsin[(n_{H}−n_{L})/(n_{H}+n_{L})]≅(4/π)(n_{H}−n_{L})/(n_{H}+n_{L})]. As the refractive indexes have a nonlinear component n₂(E²) function of the intensity of the impinging lightwave, at the very high powers achievable with highly focused ultrafast lasers, it is possible to appreciably change the refractive indexes of one or both components of the dielectric mirror by illuminating the stack with a high intensity focused pulse and thus shift the wavelength of full reflection, change the reflection coefficient and broaden the width of the stop band.

Semiconductor doped glasses exhibit high refractive indexes of n₀=2.5-3 and high nonlinear coefficients n₂. The nonlinear coefficient n₂ may change by more than an order of magnitude, depending on many factors, such as the energy of the bandgap E_{g} of the amorphous semiconductor, the doping ratio, the size of the nanoparticles dispersed in the matrix and other factors. Specifically in cadmium sulfur selenide doped glass (CdSₓSe₁₋ₙ) the nonlinear coefficient n2 has been measured to be from 10⁻¹² cm²/W to as high as ˜2.10⁻¹⁰ cm²/W. However as the refractive index increases at the edge of a bandgap and as it is possible to structure and shift the bandgap of chalcogenide glasses so as to approach the two photon sum energy (1.6 eV) of the 1.55μ lightwave, by changing the relative proportions of its constituents, the nonlinear refractive index coefficient can be maximized.

Highly non-linear materials include semiconductor doped glasses, chalcogenides and certain polymers such as polydiacetylene or MNA (2-methyl-4-nitroaneline). It is understood that other materials may be employed by those skilled in the art. Consequently, an exhaustive list of possible materials used to create these components is not offered herein.

The absorption of an optical beam in an amorphous glass behaves as A=(1/ν)(hν−E₀)² where E₀ is the optical gap, also called the Tauc gap. Therefore if the sampling beam is either a Yb:GdCOB femto-laser emitting 1.17 eV photons or a Cr: Forsterite femto-laser emitting 0.98 eV photons, the combined two-photon energy, together with the 0.8 eV signal beam photons, will be either 1.97 eV or 1.78 eV. This excitation energy is very close to the Ge₂Se₃ optical gap of 1.9 eV. Slightly changing the proportions of Ge and Se in the chalcogenide glass, the optical energy gap of the Ge_{y}Se_{1-y} can be structured to be either close to 1.97 eV or 1.78 eV, thus maximizing the absorption and the nonlinear refractive index coefficient n₂. The same strategy of changing the proportion of its constituents can be used for slightly increasing the optical gap of 1.74 eV of the As₂Se₃ chalcogenide glass, so as to be slightly higher than the two-photon energy of 1.78 eV of the combined signal beam of 0.8 eV photons and the Cr: Forsterite photons of 0.98 eV.

When the two-photon energy is close to the resonance E_{TPA}˜E_{Tauc} the nonlinear refraction coefficient n₂ may be as high as n₂=2.10⁻³ cm²/W

A 1W average power, f=100 MHz π=10 fs femtolaser's effective power is P_{eff}=P(1/πf)=10⁶W; if focused at (10μ)² the localised effective power is 10¹²W/(cm)²

Therefore n₂I=[2.10⁻³ cm²/W[]10¹²W/cm²]=0.2.

As n=n₀+n₂I , the refractive index of the As_{y}Se_{1-y} chalcogenide glass may change from 2.8 to 3 when irradiated by the high intensity sampling beam 26 focused by suitable optics 45 onto a tubular focus of 10 μ diameter.

Thus a dielectric mirror can be structured with alternating layers of the same semiconductor doped glass where the doping or particle size is slightly different, resulting in slightly different refractive indexes, say n_{L}=2.8 and n_{H}=2.9. Illuminating the stack with a high intensity light beam will change both refractive indexes (n_{H} and n_{L}, which are made of substantially the same material, by the same amount. As the width of the alternating layers d_{H} and d_{L} stays the same, increasing the refractive indexes by, say, 1%, will shift the wavelength λ₀ also by 1%, from 1550 nm to 1565 nm. The width of the almost fully reflecting stop band that initially was Δλ=(4/π)(n_{H}−n_{L})/(n_{H}+n_{L})=2.234% λ₀=34.62 nm will shrink percentage wise to 2.212% λ₀, but given the overall shift of λ₀ from 1550 nm to 1565 nm, will slightly increase to Δλ₀=36.4 nm. the total effect is the shift of the stop band from 1550±17.3 nm to 1565±18.2 nm. Thus a lightwave at 1540 nm that previously would be within the fully reflecting bandwidth from 1532.7 nm to 1567.3 nm would after the high intensity illumination find itself outside the new fully reflecting bandwidth extending from 1546.8 nm to 1583.2 nm and would therefore be transmitted.

The following approximate calculation shows that the bandwidth can be changed appreciably by using high intensity VCSELs. High power, ultrafast, side-pumped mode-locked VECSELs have been shown to emit at 980 nm an average power of ˜1W at up to 10 GHz repetition rate. Using such a VCSEL of τ=12.510⁻¹² sec (half bit length in a 40 GHz communication network), f=1.25 10⁹ Hz repetition rate (equal to 64 bit length words) and a fiber of 3μ diameter (A=7μ²), gives a local intensity per pulse of ˜1GW/cm². Under these conditions the nonlinear component of the refractive index, may be as high as n₂I=2.10⁻¹⁰ 10⁹=0.2 or a change of close to 7%.

The change of the refractive index is an ultrafast process as the relaxation time of the carriers in CdSSc nanocrystal doped glasses has been measured to be in the 100 fs range.

The high intensity sampling beam 26 ought to be co-linear with the signal beam 24I and focused onto its path in order to maximize its effectiveness.

As we shall also see in conjunction with FIG. 11, two or three dimensional photonic crystals structured to contain “defects” within the periodic crystal may exhibit effective nonlinearities several magnitudes larger and enable switching a lightwave from a reflective to the transmission mode with lower power.

FIG. 5 illustrates an improvement of the switchable mirror gate illustrated in FIG. 4 by inserting a thin layer of a thresholding saturable absorber 25 such as InP or a layer of nanotubes, between the switchable multilayer dielectric mirror 30 and the interference filter 28. As the positioning of the signal beam at the edge of the stop band at λₑ 22 combined with the shift of the stop band 20 may not be large enough to turn the mirror from fully reflective to fully transparent, the positioning of the signal beam at the very edge of the stop band at λₑ₋ 22a at less than a fully reflective position, (say at 99% instead of 99.99%) will result always in the transmission of a small portion (in this case 1%) of the signal beam. Adding a thin layer of a saturable absorber will absorb the signal under the threshold and will prevent the exit of any signal from the S-Gate. Thus it is always preferable to deposit the multilayer dielectric mirror 30 upon a thin substrate of a saturable absorber material 25; in the following the term of “switchable dielectric mirror” will always refer to a multilayer dielectric mirror backed by a saturable absorber.

FIG. 6 shows an alternative embodiment of the S-Gate illustrated in FIG. 4 where the high intensity sampling beam illuminates the multilayer dielectric mirror, from a side direction orthogonal to the switchable dielectric mirror. The bottom plate is first coated with a narrow stop band filter 28I centered around the wavelength λₛ 27 of the sampling beam that prevents it from entering the region where the signal beam propagates by reflection from one plate to another, from an S-Gate to the adjacent one, while letting the signal beam traverse it and enter the multilayer switchable dielectric mirror 30E at all times. In this geometry too, the presence of the sampling beam 26E switches the mirror 30E from reflective to transparent in respect to wavelength λ₀ of the signal 24I, and lets it traverse the dielectric mirror. The signal beam can then be focused by suitable high N.A. optics 32 into a fiber 34 or stay in free space for further processing. The exiting signal beam may also be detected by a photoelectric detector 33 such as a photomultiplier (PM) or a semiconductor Avalanche Photo Detector (APD) and may further be processed electronically. This geometry simplifies the implementation of the structure of the switchable mirror Gate, as the source of the sampling beam 26E may be much closer to the switchable mirror and even be integrated with it.

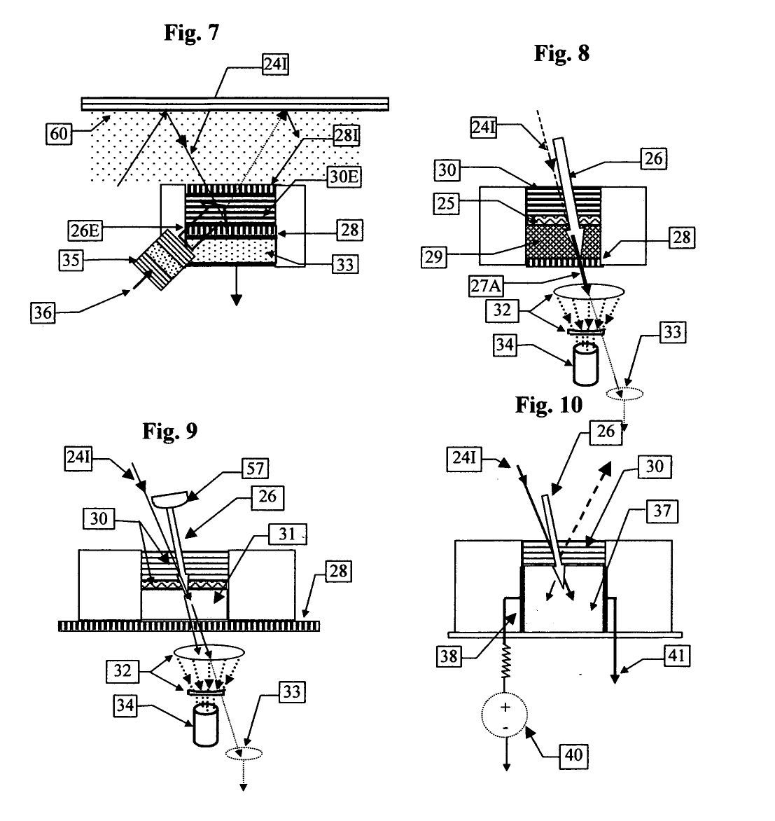

FIG. 7 illustrates a compact switchable mirror gate manufacturable using microelectronics technology. In normal operation when there is no sampling beam, the signal is reflected by the switchable dielectric mirror, whose operation is explained above in conjunction with FIG. 4, after crossing a narrow band interference filter 28I, whose function is to suppress the sampling beam 26E and prevent it from entering the medium where the signal beam 24 propagates by reflection between the top dielectric mirror 60 and the bottom one 30. The sampling beam 26E may be generated by a side emitting semiconductor laser 35 grown at the side of the multilayer dielectric mirror 30E, when triggered externally 36 by an electrical pulse synchronized with the main signal, thus illuminating the switchable dielectric mirror from the side, orthogonal to it. The high intensity sampling beam 26E shifts the dielectric mirror stop band and lets the signal beam pass and enter an Avalanche Photo Detector 33 situated next to the illuminating laser 35. A second interference filter 28, suppresses reflections of the sampling beam 26E into the APD 33.

FIG. 8 shows a different embodiment of the switchable mirror Gate illustrated in FIG. 5 by adding amplification of the sampled signal. This embodiment is particularly suitable for “Analog Sampling Gates”. The signal beam first 241 traverses the switchable mirror (the multilayer dielectric mirror 30 backed by a thresholding saturable absorber 25), that has been turned transparent by the high intensity sampling beam 26 and, they both enter co-linearly into a Raman active crystal 29 such as Ba(NO₃)₂ (or CaCO₃, NaNO₃, NaBrO₃, Na₂(SO₄), NaClO₃, KGd(WO₄)₂ and LiIO₃. The higher energy, high intensity sampling beam interacts with the co-linear signal beam which is at a Stokes wavelength, in the high polarizability molecular Raman active crystal, along a small tubular region of 1-5 μm diameter and amplifies it by the Stimulated Raman Scattering (SRS) effect. The SRS effect is most effective when the signal beam is at a Stokes wavelength of the stimulating Raman beam, both beams are co-linear, propagate in the same direction and have the same linear polarizations. If both the signal beam and sampling beam are derived from the same source and are also coherent the effect is particularly strong. For example a modulated 1.55 μm lightwave, propagating within a Raman-active medium such as a Barium Nitrate crystal Ba(NO₃)₂ will be amplified, when in spatio-temporal coincidence with a high intensity lightwave at 1.34 μm wavelength, the excess energy going into phonons, exciting the crystal's vibrations. Thus a spatio-temporal coincidence of the signal and sampling beams will amplify the 1.55 μm signal beam, above a given threshold. Note that although the temporal coincidence window may be short, the interaction time between the two beams traveling along the same path, may take much longer, thus greatly contributing to the effective amplification, without broadening the pulse width. Thus in such a Raman S-Gate the Raman active crystal ought to be as long as practical, provided that great care is taken in aligning both beams. The amplified signal beam then traverses the interference filter 28, while the sampling beam is suppressed by it. The signal beam may then either stay in the optical form for further processing in the optical domain, in which case it may be inserted into a fiber 34 by high N.A. optics 32 or it may be moved into the electrical domain by conversion in a Photo detector (PM or APD) 33.

FIG. 9 illustrates a different embodiment of the S-Gate, where the high intensity sampling beam 26 after switching the dielectric mirror 25P from reflective to transparent, interacts with the signal beam 24I in a Two Photon Absorbing material (TPA) 31 along a 500 μm long path that absorbs both the signal 24I and sampling 26 beams, but is transparent to the frequency-sum beam. The sampling beam 26, is focused by suitable optics 57 onto a long tubular focus situated in the TPA material 31 along the path of the signal beam 24I, so as to maximize the photon density and the probability to interact with the signal beam. The interaction between the signal and sampling beams is instantaneous generating a frequency sum beam within femtoseconds. Many binary or quaternary semiconductors such as InP, InGaAsP, GaAs, AlGaAs exhibit Two Photon absorption at relatively low energies while ZnS, CdSe, CdS, and CdTe are suitable Two Photon Absorbers at higher energies. Thus for example a signal beam at 1.55 μm encoded with a data train, when interacting with a second lightwave of 0.85 μm in a AlGaAs diode, will generate a third beam of 549 nm and modulated as the coincidence of the two lightwaves. It is understood that other materials may be employed by those skilled in the art. Consequently, an exhaustive list of possible materials used to generate TPA is not offered herein. The two photon signal beam, at a lower wavelength of the original beam, may then either stay in the optical form for further processing in the optical domain, in which case it may be inserted into a fiber 34 by high N.A. optics 32 or it may be moved into the electrical domain by conversion in a Photo detector (PM or APD) 33 having an improved response at the lower wavelength. This embodiment is suitable for ultrafast sampling.

FIG. 10 shows an alternative embodiment of the S-Gate, where the Two Photon absorption takes place in a semiconductor P-I-N photodiode or a light emitting diode (LED) having a bandgap energy smaller than the energy of the combined signal and sampling beams but larger than the energy of either of them. In this case the frequency-sum photons exciting electrons from the valence band into the conduction band generate a current flowing between the electrodes of the biased photo-diode or the unbiased LED. Semiconductors operating as photodetectors require no external bias 40. For example AlGaAs with a proportion of 45% Al and 55% Ga has a bandgap of 1.99 eV (624 nm) and will not be excited neither by the signal beam of 1.55 μm (0.8 eV) or a sampling beam of a Cr:LiSAF laser of 850 nm (1.46 eV), but will be excited when the two beams are in coincidence and the two-photon sum energy is 2.26 eV. Equally a GaAsP photodiode with a bandgap of 1.82 eV (680 nm) will not be excited neither by the signal beam of 1.55 μm (0.8 eV) nor the sampling beam of 1056 nm (1.17 eV) of a (Yb:GdCOB) laser, but will be excited when the two beams are in coincidence and the two-photon sum energy is 1.97 eV.

The following approximate calculation gives the order of magnitude of the signal to be expected in S-Gates based on the interaction of the signal and the sampling beams in Two Photon Absorber (TPA) materials as illustrated in FIGS. 9 and 10.

The number of secondary, frequency-sum photons per molecule of the ATP material is given by:

N(t)=(½)Cσ_{ATP}(P_{sampling, effective}/hν₁) (P_{signal, effective}/hν₂)

where C is the number of molecules (or atoms) that interact given the material's thickness <d>. σ_{ATP} is the cross section of the ATP process and is of the order of 10⁻⁴⁹−10⁻⁴⁷ cm⁴ sec/photon for materials of high ATP cross section (Dendrirners based on 4,4-bis (diphenylamino)stilbene (DPAS) repeating units have a TPA cross section of 1.1 ₁₀⁻⁴⁶)

P_{sampling, eff.}/hν₁=P_{sampling}/πfs(hν₁)=5.10¹¹P_{sampling}/hν₁ for 96 =20fs, f=100 Mhz, s=(10μ)

Where π and f are the pulse width and the repetition rate of the sampling laser beam and s is the focal area of the sampling beam.

If the sampling beam is 100 mW average power, then P_{Samlping eff.}=10³² photons/sec·cm²

As P_{signal, effective}/hν₂=P_{signal}/s(hν₂)=10⁶2.10¹⁶=3.10²² photons/sec·cm² for s=(10μ)2

Thus for σ_{ATP}=10⁻⁴⁷ cm⁴ sec/molecule photon

N=C[10³² photons/cm² sec][3.10²² photons/cm² sec][10⁻⁴⁷ cm⁴ sec/molecule photon]==8.10⁷ photons/molecule sec.

The ATP material with a density of 3.10²¹ molecules/cm³ and volume of (sd)=(10μ)²500μ=5.10⁻⁸ cm³ contains 6.10¹² molecules. Therefore in a 40 Ghz communication network, one bit =25 psec will contain [8.10⁷photons/molecule sec.][6.10¹² molecules][25.10⁻¹² sec/bit]=12.10⁹ photons/bit

Table 2 shows the wavelength of the frequency-sum photons generated in the TPA medium 8 by a signal beam in the communication C band that interacts with a sampling beam of certain Femtolasers; it also shows the constraint on the semiconductor bandgap.

TABLE 1

| | Sampling beam source | | | |
|---|---|---|---|---|
| | Ti: Sapphire | (Cr: LiSAF) | (Yb: GdCOB) | (Cr: Forsterite) |
| Wavelength | 800 nm | 850 nm | 1056 nm | 1260 nm |
| Energy | 1.55 eV | 1.46 eV | 1.17 eV | 0.98 |
| Signal beam Wavelength | 1550 nm | 1550 nm | 1550 nm | 1550 nm |
| Energy | 0.8 eV | 0.8 eV | 0.8 eV | 0.8 eV |
| Sum beam wavelength | 527 nm | 549 nm | 628 nm | 694 nm |
| Energy | 2.35 eV | 2.26 eV | 1.97 eV | 1.78 eV |
| E_{g} of TPA medium | 1.55 < E_{g} < 2.35 | 1.45 < E_{g} < 2.26 | 1.17 < E_{g} < 1.97 | 0.98 < E_{g} < 1.78 |

When the two photons are coherent and of the same energy, as is the case when both beams originate from the same source, and interact co-linearly in a Second Generation Harmonic (SGH) medium, the effect is more pronounced.

Another nonlinear effect suitable for implementation of the S-Gate is the change of the refractive index of certain materials, such as semiconductor doped glasses chalcogenides or certain polymers such as polydiacetylene or MNA (2-methyl-4-nitroaneline) when irradiated with high intensity light.

The relative composition (y) of a chalcogenide glass such as As_{y}Se_{1-y} may be changed so that its optical gap E_{g} may be structured to be close to the sum energy of the two beams interacting in the material, thus the refractive index of the chalcogenide will change appreciably, in the presence of a high intensity sampling pulse.

FIG. 11 illustrates an S-Gate using a directional waveguide coupler embedded in a two-dimensional Photonic Crystal, which may in principle be made of any two dielectric materials differing in their dielectric constants, such as chalcogenide As₂Se₃ glass/ air, Si/air, GaAs/GaA1As or GaInAsP/InP The column structures may be produced, for example, by femtosecond laser inscribing or chemical etching. The waveguide is constructed by eliminating columns, while leaving some of them at appropriate places as “defects” and sculpting them to the desired sizes so as to attain the characteristics of the resonant cavities. The waveguides are constructed by eliminating columns, while leaving some of them at appropriate places as “defects” and sculpting them to the desired sizes so as to attain the desired characteristics of the cavities, resonant frequency and decay time. Such a resonant cavities may reach an effective refractive index n_{eff}>10³ at resonance. Vertical confinement may be achieved by the low index reflection from the top.

The two waveguides 53 and 58 of the directional coupler illustrated in FIG. 11 are implemented by omitting a line of columns, are sufficiently close each to the other, enabling evanescent coupling between the overlapping defect modes and are separated by several connected high-Q cavities 61. The sampling beam 51 may be appropriately delayed by several connected cavities 55 structured to have zero dispersion and guided to the resonant cavities 61 by strongly bending the waveguiding route by introducing a “corner defect” 56. Prior to the arrival of the sampling beam the two waveguides 53 and 58 are under-coupled with the cavities 61. Due to the high nonlinearity of the resonant cavities 61, a moderate intensity sampling signal 51 will shift their frequency to the resonance frequency of the combined system and will turn the two waveguides critically-coupled, thus transfering the signal 57 propagating in waveguide 58 to waveguide 53 in full. The exiting signal 52 may be left in optical form or may be detected by a photodetector 52b and converted into an electrical signal.

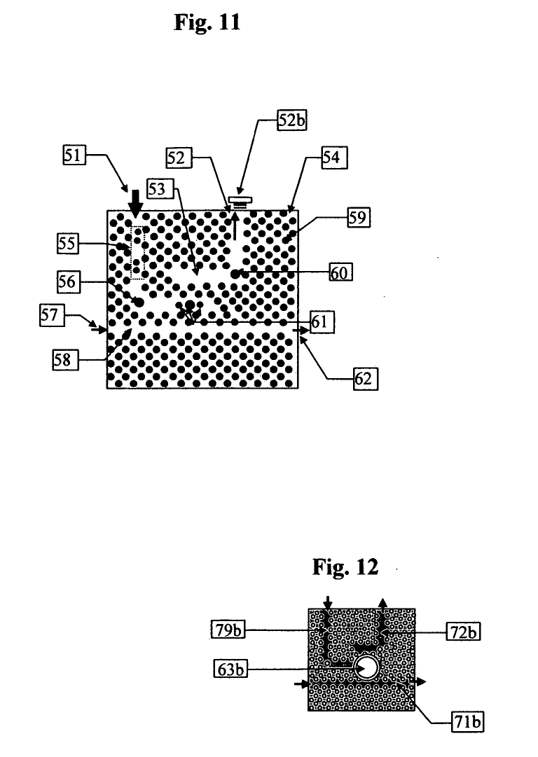

FIG. 12 illustrates a different embodiment of the S-Gate based on directional waveguide coupler evanescently coupled through a micro-ring, using a Photonic Crystal structure. The waveguides 71b and 72b are formed by omitting the low density columns along a line tangential to the periphery of the micro-ring, that may be either etched onto the substrate or grown epitaxially on it. The beam that changes the refractive index of the micro-ring and consequently its resonant frequency is also propagated along a defect line 79b.

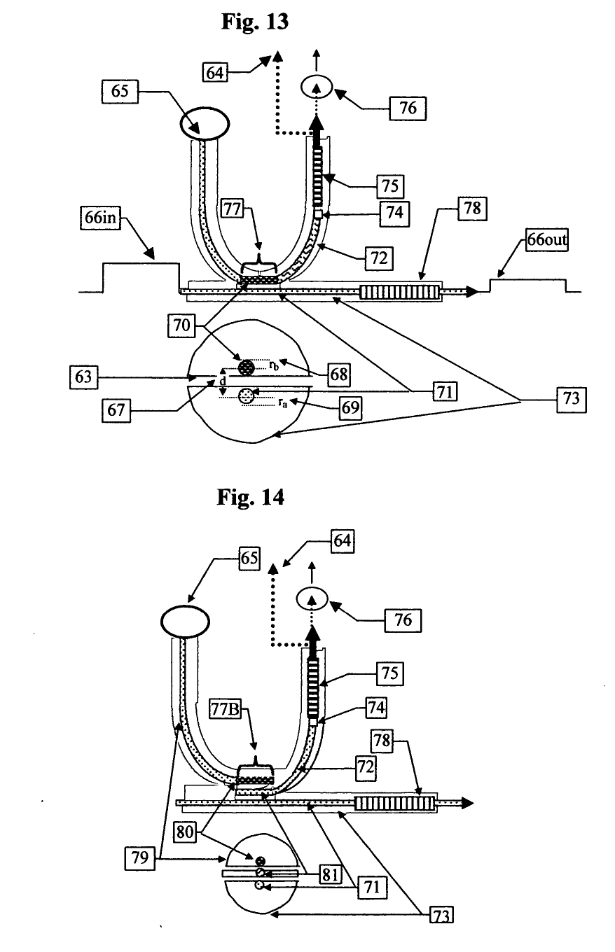

FIG. 13 illustrates an alternative embodiment of the S-Gate in the form of a directional fiber coupler in which the signal beam 66 propagating in the fiber 71 is switched onto the evanescent wave coupled second fiber 70 by a high intensity sampling beam that changes the phase of the coupled lightwave.

Coupled mode theory for waveguides and fibers coupled by evanescent waves is a well developed theory. In an asynchronous coupler where the waves in the two guides have different propagation constants β₁≠β₂, if initially all the power is in waveguide 1, then the relative power in the two guides will alternate with time and will reach its maximum in waveguide 2 according to the formula:

P₂=sin²[L(κ²+(Δβ/2)²]^{1/2}/[1+(Δβ/2κ)²]; P₁=1−P₂

Thus when the two guides are symetrical and Δβ=0, P₂=sin²(κL) and P₁=cos²(κL)→κL=π/4

This is the case of the 3 dB coupler where the power is split between the two waveguides. When Δβ=0 and κL=π/2; P₂=1 and P₁=0; in this case all the power is transferred to the second waveguide. The coupling length is defined as the length at which the power is fully transfered L_{c}=π/2κ in a synchronous system (Δβ=0) p When Δβ=0 and κL=πP₁=1P₂=0; in this case after a length of L=2L_{c}=π/κ the whole power returns to the initial waveguide.

κ the coupling coefficient between the waveguides is a complex expression given (in case of synchronous waveguide) by

κ=(k₀²/β)(n_{g}²−nₛ²)(u²w²/[(1+w)v⁴]exp-[(2w/t)(D−t)

where 78 ₀ is the wave number, β is the propagation constant in the waveguide, n_{g} and nₛ are the refractive indexes of the waveguide and the surrounding material respectively, (u) and (w) express the field distributions in guides 1 and 2, t is the width of the of the waveguide and D is the distance between the waveguides.

As can be seen from the above formula the coupling constant is an exponentially declining function of the distance (D/t) between the cores, which expresses the decline of the evanescent wave with distance. The coupling constant also increases with the “steepness” of the waveguide, the difference in the indexes of refraction n_{g} and nₛ between the cores and the cladding separating the two cores. It is also in inverse proportion to the propagation constant β₀ (˜n_{g}), which expresses the physical fact that the slower the wave propagates, the higher the energy density per unit time. Experimentally it was observed that in a symmetric silica fiber coupler where Δn between the core and the cladding is 0.3% and where t=2μ and D=3t, for a wavelength of 1.55μ the coupling coefficient was found to be κ=0.64 mm⁻¹ leading to a coupling length of L_{c}=2.46 mm.

For a wider waveguide of t=6μ but D=2t and λ=1.55μ and Δn=0.13% κ=0.714 mm⁻¹ leading to L_{c}=2.2 mm.

The coupling coefficient can be maximized by maximizing An and minimizing D/t and t.

Changing the propagation constant of one wave with respect to the other, for example by changing the refractive index of the second waveguide, by (Δβ)=β₁−β₂ will also change the coupling length.

From the above equation it follows that power transfer may be prevented by making the propagation constant β₁ larger than β₂ so that

(Δβ)=√3κ=√3π\2L_{c}; as L_{c}=π/κ→Δβ=√3π\2L_{c}=2.72/L_{c}

For example for λ=1.55 10⁻⁶ m Δβ=Δ(2πN/λ)=2π/λ(ΔN)≅4(Δn) 10³ mm ⁻¹

If L_{c}=2.2 mm then Δβ=(2.72/2.2 mm)=1.23 mm⁻¹=4.10³(ΔN)→ΔN=3.10⁻⁴

There will be no transfer of power when Δn≅ΔN=3.10⁻⁴

The physics involved in such a case may be understood by observing that the propagation constant β behaves like a refraction index; a higher propagation constant in the first fiber as compared to that in the second fiber, actually means that the lightwave in the first fiber will be propagating slower than in the second fiber, effectively causing the shrinking of the phase difference Δφ between the two lightwaves. In effect if we look at the lightwave that is crossing over from the first to the second fiber along the coupler the part that has already crossed over will be propagating faster than the part that is just crossing over and will be interfering with it constantly, effectively eliminating the transfer of power to the second fiber. Increasing the index of refraction of the second nonlinear fiber by a high intensity beam by (n₂I) and consequently the propagation constant β₂ would decrease Δβ and slow the lightwave in the second fiber, when Δβ=0 the full transfer of the power by L_{c} is restored. If the nonlinear core of the second fiber is doped with Raman active material, the small core of the fiber (1-3μ radius) leading to very high intensities, the sampling beam will cause Raman (SRS) amplification of the signal transferred, if the signal beam is at a Stokes wavelength of the high intensity sampling beam.

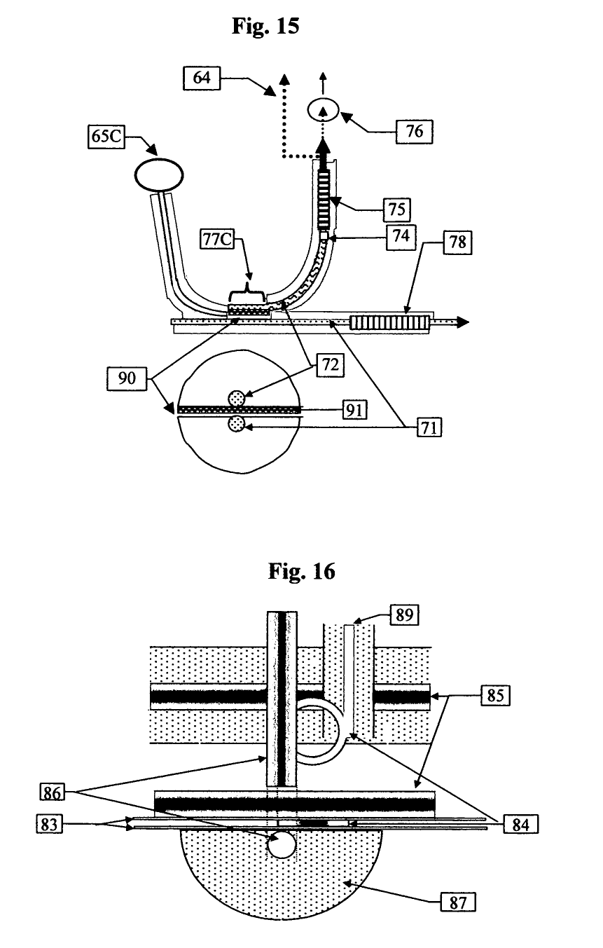

Coming back to FIG. 15, the fiber 71 where the signal 66 propagates is a single mode silica core, D shaped fiber, having a core radius rₐ1˜3μ and a refractive index of nₐ≅1.5. The fiber 71 is at a short distance d≦rₐ from a second D shaped fiber 70 whose core has the same radius r_{b}≅1-3μ and has a lower index of refraction n_{b}<nₐ. Given the the distance between the cores (d) and their radii (rₐ), (r_{b}) , the difference between the indexes (nₐ−n_{b}) is determined experimentally so that no transfer of power occurs at a coupling length L_{c}. As we saw from the numerical examples above, Δn≅1%. Fiber b has, at least in the coupling region, a nonlinear chalcogenic, chalcohalide, polyconjugated polymer or semiconductor doped core, having a high nonlinear refractive index coefficient n₂ of the order of 10⁻¹¹ cm²/W. The coupling length 77 between the two fibers is selected to equal L_{c}=π/2κ when Δβ=0. However because of the asymmetry of the two fibers having different indexes of refraction and therefore propagation constants β₁>β₂ and Δβ=2.72/L_{c}, no transfer of power to fiber (b) will occur in the normal mode. However when a high intensity pulse of a lower wavelength emitted from a laser source 65 traverses the nonlinear element 77 of the second fiber, the refractive index increases by n₂(a)I and causes the propagation constants β₁ and β₂ to equalize. A 10 mW average power laser emitting 1 psec pulses, at a 1 GHz repetition rate, into the fiber of cross section A=10μ² has an equivalent power of 0.1 GW; If the nonlinear coefficient is 10⁻¹¹ cm²/W the change of the refractive index is 10⁻¹¹10⁸=10⁻³. Note that although the high intensity pulse I_{b} is coupled to fiber (a), its refractive index does not change appreciably as its nonlinear constant n₂(b) is 10³ times smaller.

The equalization of β₁ and β₂ causes the power to transfer from fiber (a) to fiber (b). If fiber (b) has a Raman active section 72 after the coupler and the wavelength of the laser is such that the signal is at a Stokes wavelength, the high intensity pulse I_{b} will amplify the signal that was picked up at the coupler. This optical amplification, before the signal is converted to electrical form may be of great importance, if the signal propagating in fiber (a) has a very low amplitude close to the noise level.

Fiber (a) has after the Raman active section a short section of saturable absorber 74 such as a film of InP or a layer of carbon nanotubes . The purpose of the saturable absorber is to suppress any low intensity signal that may cross over the coupler, in spite of the suppression of the power transfer by selecting the Δβ=2.72/L_{c}. The high Intensity pulse turns the saturable absorber to transparent and lets pass the amplified signal. The grating filter 75 suppresses the high intensity sampling beam that has a lower wavelength and transmits the higher wavelength signal. The signal is then either fed to a photodetector 76 and converted to an electrical signal or left in an optical form for further optical processing.

FIG. 14 shows an alternative embodiment of the S-Gate where the switching of power from one fiber to the second in a directional coupler, is assisted by a third fiber 77B placed in proximity to the second fiber 81. The first D shaped fiber 73 where the signal propagates is in close proximity to the second fiber 81 along a length L_{c}=π/2κ and the third fiber 79 is in close proximity to the second fiber 81 but at a relatively larger distance from the first fiber. The coupling coefficient declining exponentially with the distance between the fibers, κ₁₂≅κ₂₃>>κ₁₃ and as the coupling κ₁₃ may be neglected, the 3 fiber system may be viewed as fiber 1 coupled to the agregate of fibers 2 and 3, where the coupling constant to be considered is κ_{1,(23)}. As described in connection with FIG. 15 the difference in the refraction indexes of the fibers, may be tuned such that the difference in the propagation constants β₁−β₂₃=2.72/L_{c} causes no transfer of power along the length L_{c} from fiber 1 to fiber 2 and consequently to fiber 3. Fiber 3 may have the same refractive index as fiber 2 and consequently the same propagation constant β₂=β₃; therefore it is tuned to full transfer of the power from fiber 2 in a coupling length L_{c}=π/2κ₂₃; however as there is no power transfer from fiber 1, there is nothing to transfer to fiber 3. Changing instantaneously the refractive index of the third fiber 79 that has a high nonlinear coefficient in a section of the coupler 77B, by illuminating it with a high intensity pulse emanating from a laser 65, increases the coupling constant κ₂₃ between fibers 2 and 3, the propagation constant β₃ and the effective coupling length L_{c}. As a result the system comprising fibers 2 and 3 may be viewed as having a higher combined propagation constant β₂₃. If the change in the refractive index n_{c} of fiber 3 is such that now β₁=β₂₃ then the power will transfer from fiber 1 to fiber 2. The power balance between fibers 2 and 3 depends on the new propagation constants β₂ and β₃ and the new coupling coefficient κ₂₃. Selecting judicously the characteristics of the coupler (2,3), mainly the indexes of refraction and the nonlinear coefficient, enables to maximize the portion of the transferred signal that remains in fiber 2. The high intensity lower wavelength sampling signal from fiber 3(79) being coupled to fiber 2(81), amplifies the signal transferred from fiber 1(73) to fiber 2, if it fulfills the conditions needed for Raman amplification, in the section 72 of the fiber doped or containing Raman active material. Saturable absorber 74 suppresses the low intensity signals that may be transferred from fiber 1 to fiber 2, even in the absence of a sampling signal. Grating filters 75 and 78 suppress the sampling signals that are coupled to fibers 2 and 3.

FIG. 15 illustrates another variation of the geometry of the S-Gate based on a directional fiber coupler where the interference in the coupling between the fibers is effected by a thin film having a large nonlinear coefficient and whose index of refraction is strongly changed by illumination from a high intensity sampling beam. A thin film of preferably semiconductor material 87 having a high nonlinear coefficient n₂ is deposited on the face of the second D-shaped fiber 72 evanescently coupled to the first fiber 71. The film may be illuminated by a hollow fiber conducting a high intensity beam from an ultrafast laser 65C. As described in great detail in connection with FIG. 15, the indexes of refraction of the fibers are selected so that the difference in the propagation constants β₁−β₂=2.72/L_{c} and the coupling distance is L_{c}=π/2κ. In the absence of the high intensity beam to illuminate the thin film 87, no power is transferred from fiber 1 to fiber 2. However when the thin film 87 is illuminated by a high intensity light beam the propagation constant β₂ is increased and Δβ may be nullified so that the full power is transferred from fiber 1(71) to fiber 2(72) coated with the thin film 87. Grating filters 75 and 78 suppress the sampling beam that may leak while the saturable absorber 74 suppresses any weak signal that may cross over even when β₁−β₂=2.72/L_{c} due to the sensitivity of the mismatch between the propagation constants.

FIG. 16 illustrates an alternative embodiment of the S-Gate based on fiber couplers, in view of minimizing the distance between adjacent S-Gates and reducing the power needed to switch the signal from one fiber to another. In this embodiment the coupling is accomplished in the vertical dimension using a micro-ring 84 evanescently coupled to the two fibers 85, 86 laying below and above the micro-ring respectively in an orthogonal direction one in respect to another. The switching of the signal from one fiber to the second fiber laying in an orthogonal direction above the micro-ring is effected by changing its refraction index by illuminating it with a moderate intensity sampling beam 89.

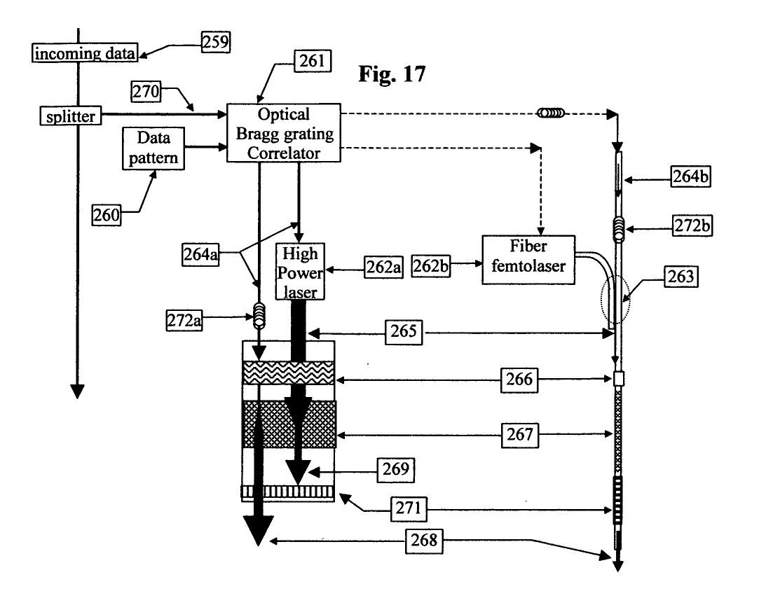

FIG. 17 illustrates a “Raman Trigger”, a high intensity pulsed source whose power output is determined by a pulsed high power source while its wavelength and timing accuracy by an auxiliary low intensity device. The ability to generate precisely timed high intensity pulses, is an extremely important feature for sampling an array of S-Gates simultaneously, following the determination of the start of a data train. The problem that a “Raman Trigger” circumvents is that a pulsed laser with moderate power, cannot be triggered with very high temporal precision. However the start of a data train by using for example a passive optical multi Bragg gratings correlator 261 to compare the data train 270 with a pre-known pattern 260, yields an optical signal 264a which is very precise in its timing. Thus a signal known to be precise in time, albeit of low intensity is fed to the proposed device, the “Raman Trigger” which is composed of a fast saturable absorber 266 that rejects partial correlation triggered weak signals, followed by a Raman active crystal 267 and ending with a wavelength filter 271. The precise optical signal 264a is also used to trigger a high power laser 262a for example by initiating the population reversal within the laser cavity by illuminating the saturable absorber and initiating its switch from absorbeer to transparent or controlling the reflectivity of one of the mirrors by controlling its polarization. The high power laser emits a high intensity pulse 265 at a higher energy (lower wavelength) so that its first Stoke's beam corresponds to the signal's wavelength. For example if the signal 264a has a wavelength of 1550 nm, the High Power Laser has to emit at 1340 nm so that within a Ba(NaO₃)₂ crystal 267 its first Stoke's component will be resonant with the signal's 264a wavelength and will be able to amplify it by the Stimulated Raman Scattering (SRS) effect. The output of the correlator is slightly delayed 272a in order to compensate for the delay in starting the High Power laser and synchronise it with its output high intensity pulse 265 as much as possible.

“The “Raman Trigger” may be implemented in free-space, in optical fiber technologies or in a Photonic crystal. In the absence of the high intensity beam 265, the triggering pulse 264, will be absorbed in the thresholding fast saturable absorber 266 which may be a thin layer of a semiconductor such as InP, InGaAsP or a layer of nanotubes on a polymer substrate. The saturable absorber serves to eliminate weak optical pulses emitted by the correlator resulting from partial correlations However in the presence of the high intensity beam 265 that turns the saturable absorber 266 transparent, the triggering pulse 264a co-linear with the High Intensity pulse 265 along a path within the Ba(NaO₃)₂ crystal 267, and at resonance with its first Stoke's component at a lower wavelength will be strongly amplified by the SRS (Stimulated Raman Scattering) effect. The residual pumping beam 269 will be suppressed by the interference notch filter 271 while the strongly amplified signal pulse, will traverse the interference filter 271 and exit the Raman Trigger. The exiting pulse 268 will have the timing characteristics of the pulse 264a and a much higher intensity.

Note that as the signal and amplifying pumping pulse are co-linear they may traverse a long path together in the Ba(NaO₃)₂ crystal notwithstanding the narrow pulsewidth of the signal pulse 264a.

In the fiber optics implementation the “Raman Trigger” can be built by inserting the output of a high intensity fiber laser 262b through a coupler 263 into the fiber where the precise optical trigger pulse generated by the Bragg correlator 264b is traveling after being properly delayed 272b to synchronize it with the fiber laser pulse. For this application, it is advantageous to use photonic crystal “holey” fibers as they can transport much larger power in single mode than silica fibers. When in temporal coincidence both beams first cross the saturable absorber 266 which is built into the fiber by doping it with a semiconductor such as InGaAsP, and then enter co-linearly a long section of the the fiber doped with crytalline Ba(NaO₃)₂. There the power is transferred from the high intensity lower wavelength beam to the higher wavelength signal pulse 264b along a relatively long path. After traversing the Raman active medium, the residual of the pumping beam is reflected back by a grating mirror 271 that lets pass the higher wavelength amplified beam 268.

The process in the Photonic crystal implementation is the same other than the manufacturing technology that consists in inserting the saturable absorber and the Raman active material in the waveguide. However as the waveguides in a photonic crystal are much shorter the path for the Raman amplification too is short and the amplification of the signal pulse obtained is much lower.

On the other hand the intensity needed to sample an S-Gate in a Photonic crystal is also much lower, which may make the Raman Trigger implemented in a photonic crystal, a viable option.

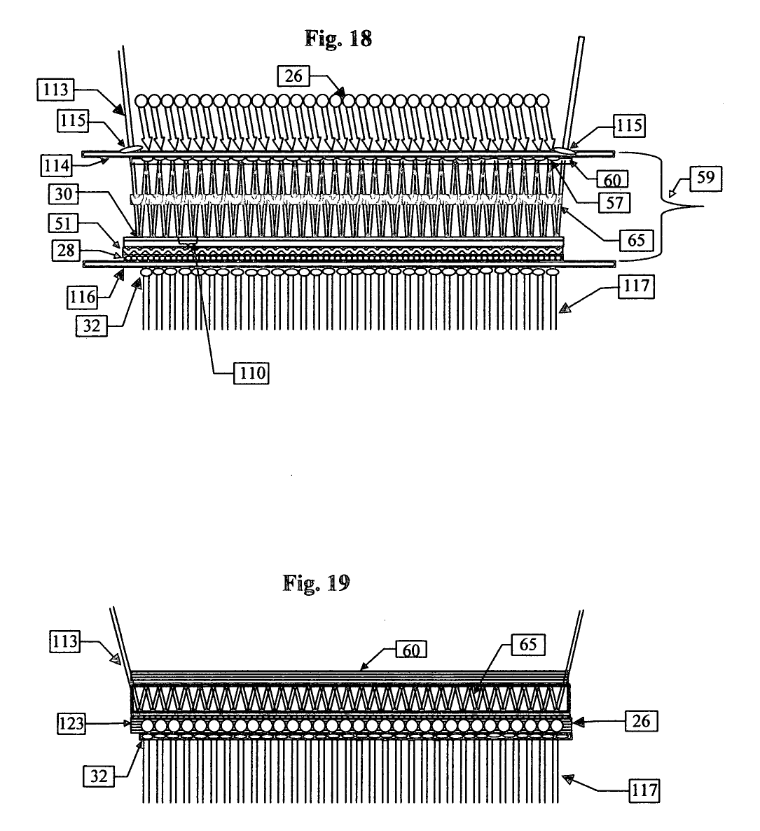

FIG. 18 shows the structure of a fabry-perot etalon like S-Gate array containing 32 switchable mirror S-Gates, built out of two parallel plates 114 and 116, coated internally by dielectric mirrors 60 and 30, where the signal propagates by reflection between the plates.

The signal beam passes from one S-Gate to the next by reflection between two closely spaced dielectric mirrors 30, 60 and is focused onto each S-Gate by GRIN (GRadient INdex) lenses 65 placed between the dielectric mirrors, to prevent the reflected beam from diverging. In order to focus strongly the sampling beam onto a small (˜1−10 μm) region of the material where the nonlinear interaction between the two beams takes place, lenses 57 with high N.A. may be embedded (or etched) onto the upper plate, where the sampling beam enters the device.

As the reflection angle of the mirrors is a function of the indeces of refraction of the thin films and the substrate, and as they change with wavelength, consecutive reflections along the plates will cause spectral dispersion and widening of ultrafast pulses. This dispersion may be corrected by making the top plate dielectric mirror 60 chirped, giving it a Negative Group Velocity Dispersion (NGVD). Chirped dielectric mirrors are constructed by stacking layers of thin films with increasing thicknesses (e.g., quarter-wave layers with a gradually increasing Bragg wavelength) such that longer wavelengths penetrate and are reflected from deeper layers of the mirror structure, and therefore experience a longer path, producing a negative group velocity dispersion (NGVD) and thus compensating for the chromatic dispersion.

It is advantageous to introduce, the sampling beam 26 through the chirped mirror 60, at the same inclination and co-linear to the signal beam so as to maximize their length of interaction in the lower dielectric mirror. The sampling beam 26 after shifting the dielectric mirror stop band, is suppressed by the interference filter 28. The signal beam 113 after traversing the lower dielectric mirror and the interference filter 28 is channeled into an optical waveguide or fiber 32 or detected by an Avalanche Photo-Diode (APD) for further processing.

The distance between the plates 59 of an S-Gate array is set to accommodate the length of data sequences to sample, whether bits, bytes, longer words, or entire packets. Obviously the length of the sampling pulse has to be commensurate with the length of the of the data train that is to be switched. It is advantageous to minimize the distance r between two S-Gates 110 and increase the distance d between the plates 59, as this will also minimize the length of the device. For example if the reflection of the beam is by θ=6⁰, then 2 tan 3⁰˜0.10=r/d and for detecting bits, the path (S) between two reflections ought to be c/f where c is the speed of light in vacuum and f is the frequency of the communication network. Table 2 gives the dimensions of the two-plate S-Gate array when one bit or one byte occupy the path between two reflections.

TABLE 2

| | f = 40 GHz | | | | | f = 160 GHz | | | | |
|---|---|---|---|---|---|---|---|---|---|---|
| | S = c/f | d ˜S/2 | r = 2dtanθ/2 | L = 32r | L = 512r | S = c/f | d ˜S/2 | r = 2dtan θ | L = 32r | L = 512r |
| Bit | 7.5 mm | 3.72 mm | 390 μ | 12.5 mm | 200 mm | 1.9 mm | 0.95 mm | 97 μ | 3.12 mm | 50 mm |
| Byte | 60 mm | 30 mm | 3.12 mm | 100 mm | — | 15 mm | 7.6 mm | 0.78 mm | 25 mm | 400 mm |

Obviously one bit, one byte or any length of a data train, can also extend over a longer or shorter path than the distance between two reflections; in such a case the dimensions of the device will change accordingly.

The two-plate S-Gate array may be implemented based on a variety of nonlinear interactions of the signal beam, carrying the encoded data, in spatio-temporal coincidence with a sampling beam, as illustrated in FIGS. 5 through 10. The speed of the interactions between the two beams, is dependent on the nature of the specific effect occurring in the nonlinear medium. The fastest responses are obtained with S-gates based on SGH (Second generation Harmonics) and Raman effect.

The thin parallel signal beam 103 reflected by the dielectric mirrors 60 and 30 on the upper and lower plates, propagates within the etalon S-Gate array, advancing between any two reflections by a distance (r) 110. However as the beam tends to diverge between any two reflections a lenslet array 65 made of GRIN (GRadient INdex) material refocuses the signal beam. Some of the GRIN (Gradient INdex) lenslets combine with high N.A. focusing lenses 57, inserted onto the upper plate 114 of the S-Gate array, in order to focus tightly the sampling beam onto the spot where the two beams interact.

The coatings under the switchable dielectric mirror layer on the bottom plate 2 vary, depending on the nonlinear effect selected to implement the switching mechanism that replicates the signal beam modulation onto a set of external beams. The different switching mechanisms and the respective materials were discussed above in connection with FIGS. 5 through 10.

FIG. 19 illustrates an array of integrated S-Gates where both the sampling light source and the detector are integrated with the switchable mirror and the interference filters. The S-Gates array is constructed out of a rectangular slab of transparent material such as glass whose top is coated with a chirped dielectric mirror 60 and whose bottom with a set of coatings 123. The first layer of the bottom coatings is an interference filter whose function is to stop the sampling beam 26 that illuminates the the switchable dielectric mirror, from entering the slab of material where the signal beam propagates. The second layer is a switchable dielectric mirror 30 switched by the sampling beam 26 directed to it from the side, as explained in connection with FIG. 6. The third layer is again an interference filter 28 that prevents the backscattered sampling beam 26, from re-entering photodetector layer 32.

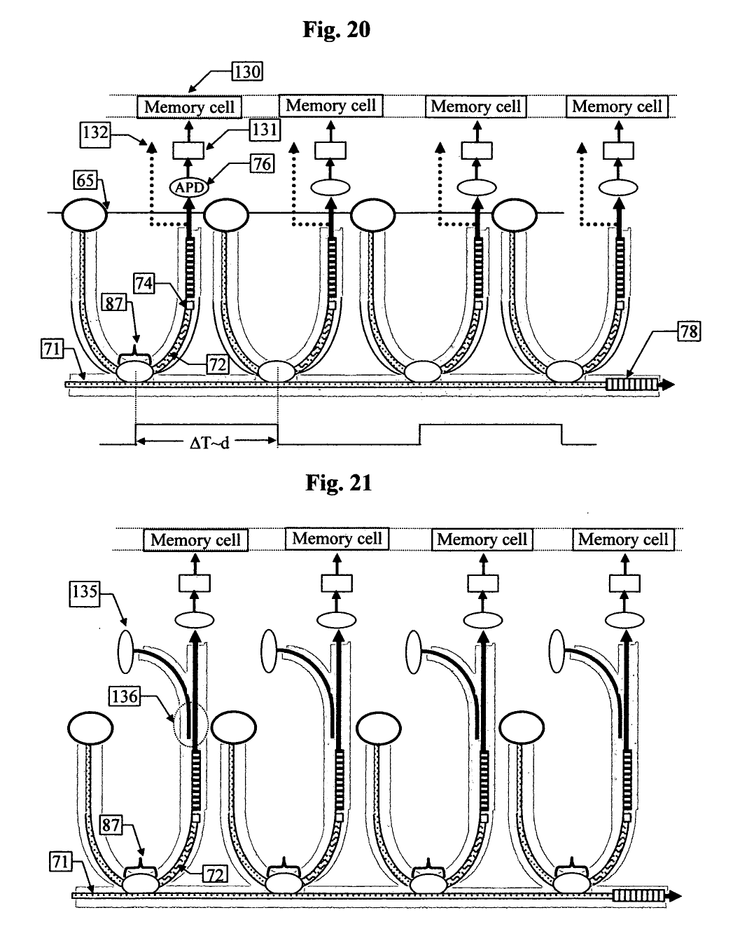

FIG. 20 illustrates an array of S-Gates based on directional fiber couplers, explained above in detail in connection with FIGS. 14, 15 and 16. Although the specific implementation of the coupling method 87 between the fiber 71 carrying the signal and the evanescently coupled fiber 72 picking up the signal are different in the three embodiments explained in conjunction with FIGS. 14,15 and 16, the operation principle of the S-gates is the same. It consists in setting the propagation constant β₂ in the pickup fiber 72 lower than the propagation constant β₁ of the fiber carrying the signal, so that transfer of power is inhibited along the coupling length; then increasing the propagation constant β₂ so that preferably it equals that of the main fiber ⊖₁ leads to the transfer of the signal that is flowing under the coupled section. This is accomplished either directly by increasing the index of refraction of the pickup fiber by illuminating it with a high intensity beam or by greatly increasing the index of refraction of an auxiliary fiber coupled to the pickup fiber, by the same means, so that it changes the propagation constant β₂ of the pickup fiber. The key to ultrafast serial-to-parallel conversion is initiating the change of the propagation constant β₂ at all the S-Gates simultaneously, for a period ΔT that equals at most, the “bit” length of the digital data train, and placing the switchable directional couplers at a distance d=v_{g}ΔT each from the next, where v_{g} is the group velocity of the data train.

The coupling length has then to be smaller than this coupler-to-coupler distance L_{c}<d; preferably much smaller, in order to accommodate the bending of the fiber. For example in a 40 GHz communication network the bit length is 25 psec corresponding in a silica fiber to a length of 5 mm, the coupling length L_{c} preferably ought to be 1-2 mm long at most. To better accommodate closely spaced couplers, the orthogonal coupling described in connection with FIG. 17 is more suitable. In such a case the pick up fiber 85 coupled to the main D-shaped fiber 86 through the micro-ring 84 enables an extremely compact array.

The high intensity sampling beam may be utilized to optically amplify the signal picked up through the coupler before processing it, as explained in connection with FIGS. 14, 15 and 16. The optical amplification boosts the minimal level of detectable signals and greatly improves the value of the device when used as a “receiver”. To ascertain the presence of a signal only when it is sampled, a thresholding saturable absorber 74 suppresses weak picked-up signals that cross over the coupler even when there is no sampling beam. The Raman amplified picked up signals are detected by an array of Avalanche Photo Detectors (APDs) 76 and shaped in a signal conditioner 131 before sent to storage in a memory register 130 with parallel access. If the S-Gate array is organized as a “word” receiver instead of the “bit” receivers currently used, aggregating, say, 64 S-Gates as a “receiver” will enable reading 64 bits in parallel into the memory Register. Accurate activation of the sampling beams generated by a VCSEL array 65 is necessary for synchronizing the start of a data train, whether this is a “word” or a Header containing several “words”. The problem of identifying the start of a “bit” is different from the problem of identifying the start of a data train and was explained in connection with FIG. 18. The Raman amplified output from the pickup fiber 132 may of course be left in the optical domain, for further processing optically, which in general is faster than electronic processing. One advantage of the parallel optical output is in conjunction with optical fourier transform cross-correlators, Bragg grating correlators or Holographic correlators, for replacing the inherently slow Spatial Light Modulators (SLMs).

FIG. 21 illustrates an S-Gate array, that can also operate in reverse, as a transceiver by. emitting in parallel data trains, feeding the secondary fibers 72 through additional couplers 136, the consecutive bits that form a data train. In such a case, the light emitters (for example VCSELs) are triggered simultaneously, each to emit the proper “bit” in the form of a pulse of a given length and level. The individual light pulses introduced through the couplers 136, are inserted into the main fiber 71 synchronously, through the couplers 87. Note that the condition of β₁−β₂=2.72/κ is not symetric; power may flow from fiber 2 to fiber 1 even when β₁−β₂=2.72/κ and power does not flow in the opposite direction. Thus the modified S-gate array may operate as an ultrafast transceiver.

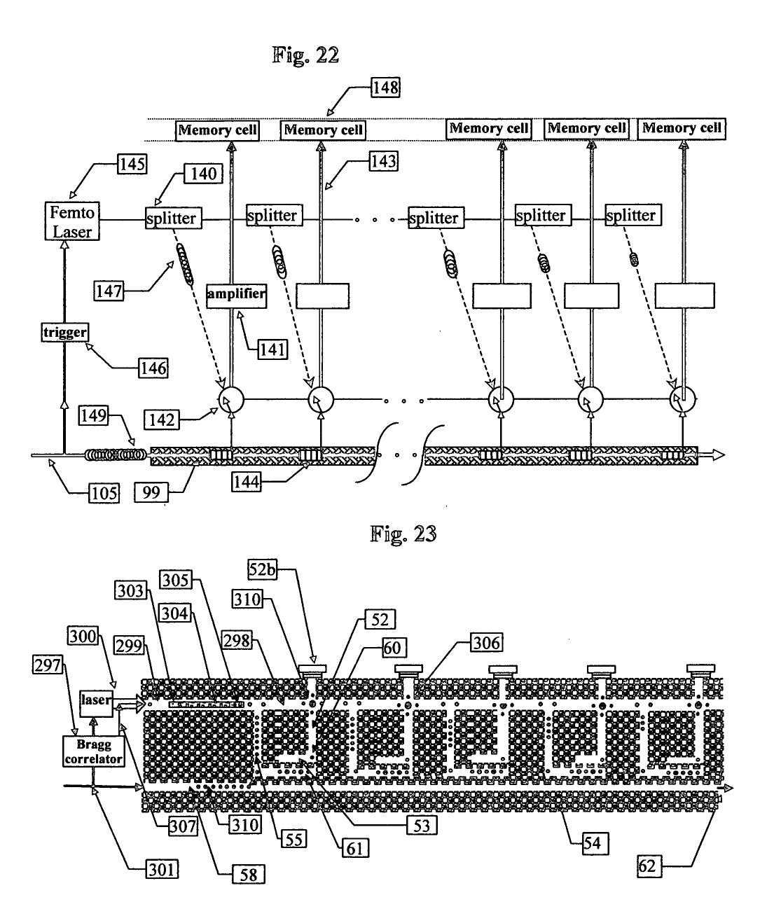

FIG. 22 illustrates an electrical serial-to-parallel converter based on an array of waveguide taps inductively coupled to an electromagnetic transmission line. The couplers are in the form of densely wound wires 144 around the central conductor 105 of the transmission line 99 as described in connection with FIG. 20. Although the tapping of the transmission line inductively reduces losses as compared to a physical contact, the losses may further be limited, by turning the inductive coupler on, only when tapping is desired. This is accomplished by closing the conduction loop of the inductive couplers by turning an array of ultrafast photoconductor switches 142 on, by illuminating them with an ultrafast laser 140 for a time period equal to a “bit” or “word” length, as desired. Advanced photoconductor switches may close the circuit in a few psec enabling to tap communication networks operating at 100 GHz. The femtolaser 145 may be triggered by a circuit 146 that senses the leading edge of the first pulse in an incoming data train or a correlator that senses a data pattern preceding a data train. The delay in determining the beginning of a data train may be taken in account by a suitable delay 149; however the timing indeterminacy in triggering the femto-laser that samples the S-Gates, is critical and determines the bandwidth of the serial-to-parallel converter. The sampling beam generated by the laser 145 is distributed between the S-Gates using splitters 140 of an appropriate ratio and suitable delays 147 for achieving simultaneous switching of all the inductively coupled sensors. The inductively sensed signals are then amplified 141 and then fed to a parallel memory 148.

FIG. 23 illustrates an ultrafast serial-to-parallel converter implemented in a Photonic Crystal structure 54 by connecting a sequence of S-Gates whose operation is described above in connection with FIG. 12. The incoming signal 301 to be read is first split and a portion of it used to activate the correlator 297 that determines the start of a data train as explained above in connection with FIG. 18. The output of the correlator triggers a high intensity laser 300, whose output is coupled into the waveguide 298 of the photonic crystal, co-linearly with the output signal 307 from the correlator towards a “Raman Trigger” consisting of a saturable absorber 303, that has been deposited into the waveguide, a Raman active crystalline deposit 304 and a filter implemented by connected resonant cavities 305. The functionality of the Raman Trigger was explained above in conjunction with FIG. 18. In the absence of the high intensity pulse emitted by the laser 300, there is no output from the Raman Trigger into the waveguide 298. However when the correlator identifies a data train, the Raman Trigger emits a high intensity sampling pulse, time correlated with the beginning of the incoming data train 301. The data train 301 is delayed by a series of connected cavities 310 in order to synchronize it with the sampling pulses. The initial sampling pulse is split at each intersection 306 by appropriate “defects”, one part proceeding to propagate in the waveguide 298 and the other part after being appropriately delayed by a series of connected cavities 55 reaches another set of resonant cavities 61; by slightly changing the refractive index of the defects, the sampling pulse changes their resonant frequencies and causes the cavities to critically couple with the waveguides 58 and 56, thus causing the transfer of the signal 301 for one waveguid to another, for the duration of the sampling pulse. The signal transferred to the waveguide 53 is guided by the defect 60 into the waveguide 52 and after crossing the intersection 310 is detected by a photo-detector 52b. The same process is repeated at each intersection 306, however as the delays 55 gradually decrease all the S-gates are sampled simultaneously.

As the amplification stage 304 of the Raman Trigger in a photonic crystal is much shorter as compared with that of an optical fiber, the amplification of the sampling pulse is much lower. However as the intensity needed to switch the signal between two waveguides in a Photonic crystal is also much lower than with a fiber coupler, the integration of the Raman Trigger with the S-Gate array in a photonic crystal makes sense. Alternatively if the Photonic Crystal Raman Trigger does not provide the intensity required to sample the Photonic S-Gates, the Raman Trigger is implemented within an optical fiber as explained above and the high intensity sampling signal is coupled directly to the waveguide 298 that serves to distribute it to all the S-Gates.

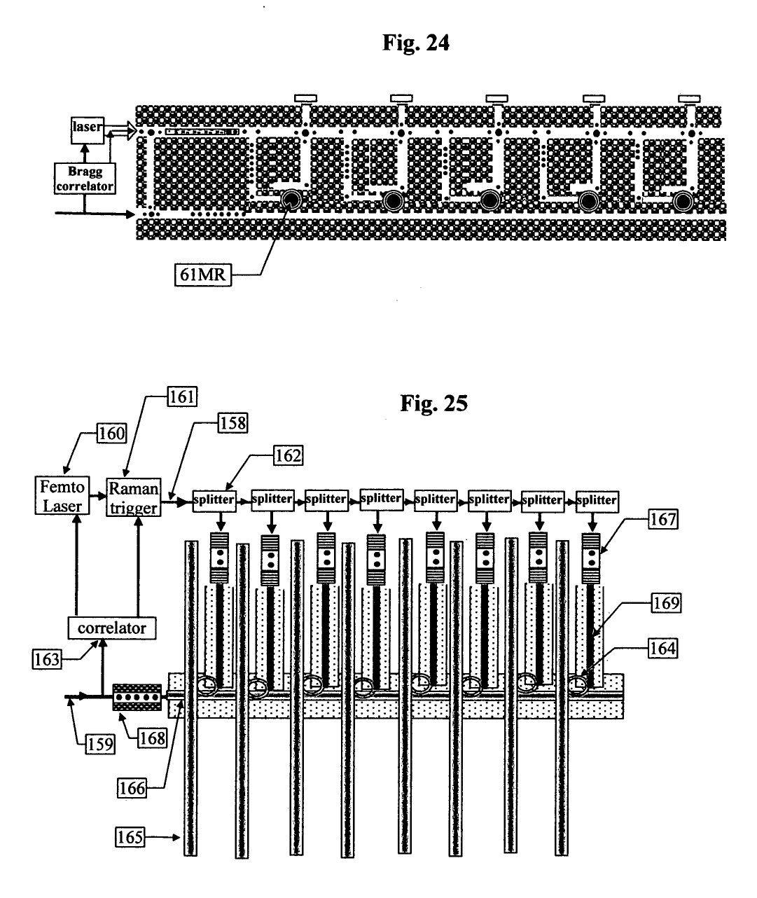

FIG. 24 illustrates an ultrafast serial-to-parallel converter implemented in a Photonic Crystal similar to the structure and functionality described in connection with FIG. 25 above with the only difference being that the directional waveguides are evanescently coupled by micro-rings 61MR. The micro-rings may be grown epitaxially on the same substrate on which the high refractive index columns of the optical crystal are grown or alternatively etched onto the same material into which the matrix of holes is etched. Critical coupling and subsequent transfer of the signal from one waveguide to another is achieved by optically changing the refractive index of the evanescently coupled micro-rings.

FIG. 25 illustrates a compact ultrafast serial-to-parallel converter where the data propagating in an optical fiber 166 along its length, is extracted simultaneously to a multiplicity of fibers 165 lying above and orthogonal to it, critically coupled by micro-rings 164 laying between the fibers and evanescently coupled to them. This geometry allows minimizing the distance between adjacent S-Gates while reducing the power needed to switch the signal from one fiber to another, due to the resonant coupling achieved by the evanescently coupled micro-rings in the vertical direction. The incoming signal is split and fed to a correlator 163 to determine the beginning of a data train by comparing it with known patterns. The output of the correlator is used to trigger a femto-laser 160 and a Raman Trigger 161 whose functio was explained above in connection with FIG. 18. The output of the femto-laser is also fed to the Raman Trigger that as explained above generates the sampling beam 158. The sampling beam 158 is distributed between the S-Gates using splitters 162. The incoming signal 159 and each sampling beam is appropriately delayed by photonic crystal delays constituted of connected resonant cavities waveguides 167, 168 in order to synchronize the signal 159 and the sampling pulses that change the refractive index of the micro-rings and thus cause the fibers to critically couple with the micro-ring resonators.

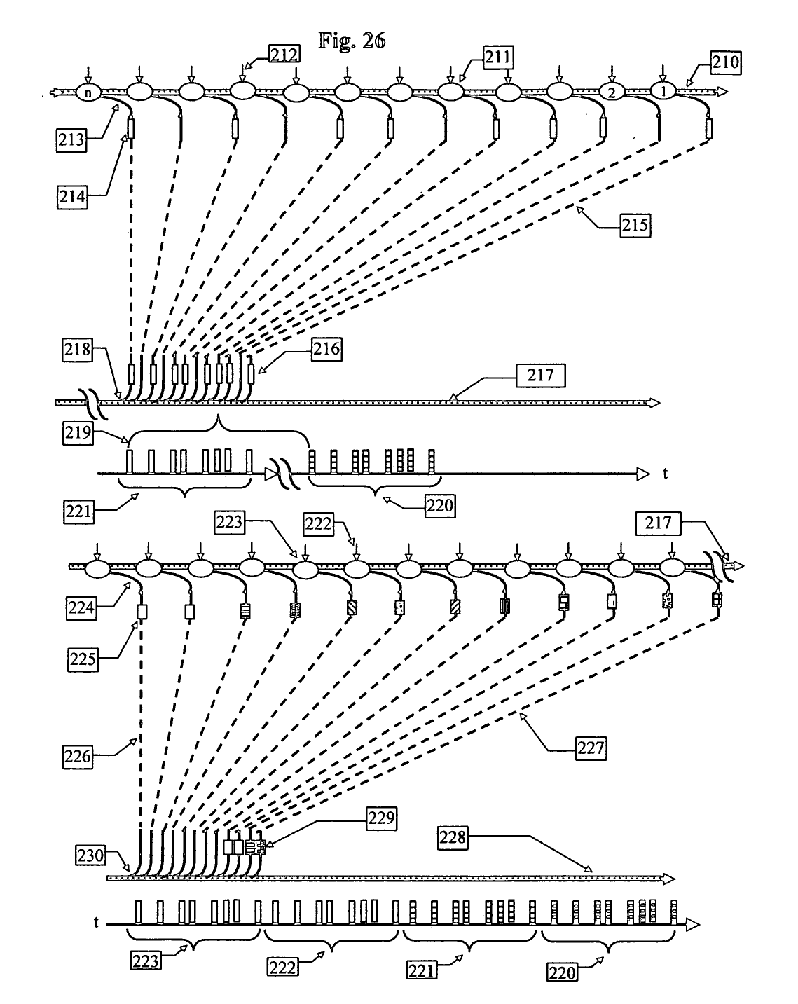

FIG. 26 illustrates a method of temporal optical compression of a long data train using an array of S-Gates based on switchable directional fiber couplers. The repetition rate of the sampling beam 212 and the frequency of the data train determine the length of the S-Gates 211 array, for example in a 40 GHz communication network where each bit is 25 psec long, if the sampling rate is 1 GHz, it follows that n=40 S-Gates are needed, in order to continuously sample the data train. If it is desired to compress the data train, say by a factor of 25, the pulse width of the sampling beam ought to be 1 psec. In this case a continous compresssion of the data train can be achieved in two stages. In the first stage n=40 bits are simultaneously sampled by n=0 switchable S-Gates( for example like the orthogonally coupled fibers), by the 1 psec wide sampling beam, thus generating at the output of the n coupled fibers 213, n=40 pulses 214 each 1 psec wide, simultaneously. The n fibers carrying these pulses are then coupled 218 (or fused) with a main fiber 217A, after cutting them to size so that each fiber is 5 mm longer than the next one, so that the respective pulse will arrive 24 psec later enabling to shorten the temporal distance between the two from 25 psec to 1 psec. Thus the train of 40 bits, 1 nsec long is compressed by a factor of 25 to a train 220, 40 psec long.

In the second stage as the repetition rate of the sampling beam is 1 GHz, after 1 nsec, a second sampling pulse samples the 40 bits following the first 40 bits, resulting as in the precedent process the generation of a second 40 bit long compressed data train 221. This second data train 40 psec long, lags after the first 40 bit long data train 220 by 1 nsec.

Assuming that it is desired to compress (m) sections of a data train each (n) bits long, the m compressed sections each 40 psec long and separated by 1 nsec each, then proceed along fiber 217 to an array of (m) switchable directional coupler S-Gates 223, separated 1 nsec (20 cm) apart and are sampled by a sampling beam 222, 40 psec wide and synchronized with the prior sampling beam 212 or derived from it. The 40 psec wide sampling pulses channel each 40 bit section into a different fiber 225. In this stage too the various sections are combined (coupled or fused 230) into a common fiber 228 after delaying each of the sections 225 differentially by 960 psec each as compared to the next one. Thus the first section 270 is delayed by m960 psec. The end result is the compression of (m)×(n) bits by a factor of 25. If m is 25 given the above mentioned factors, a 1000 bit data train 25 nsec long is compressed by a factor 25 to 1 nsec. This process may be repeated to compress longer data packets.

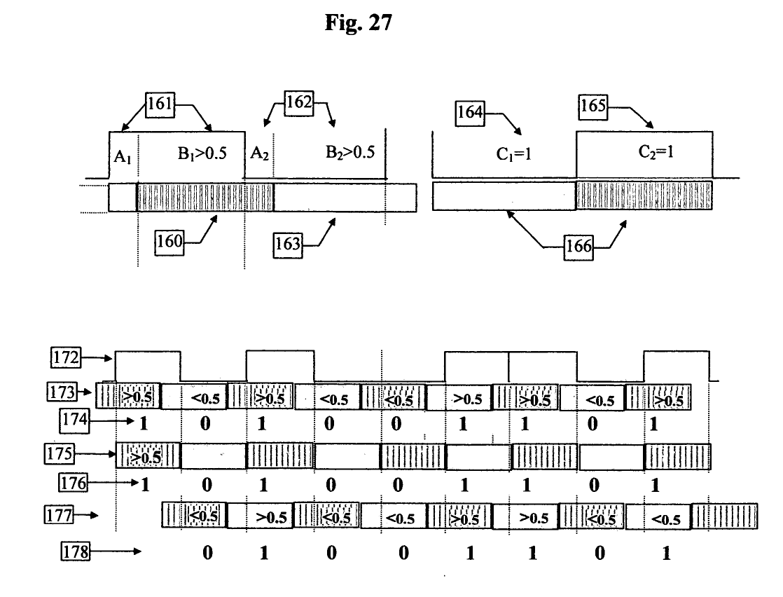

FIG. 27 illustrates a decoding scheme that alleviates the timing sensitivity of the sampling intervals in respect to the bit periods. The timing of the sampling beam in respect of the propagating data train is critical, as the beginning of the sampling beam may catch a “bit” anywhere along its width; specially if the sampling beam's width equals the “bit” length. In this case the overlaping sections may extend from zero to full overlap and the level of the extracted signal from nil to a maximal value. In fact, as most of the time there is no full overlap with any given bit, the extracted signal is always a result of a partial overlap combinations with two adjacent bits. However as illustrated in FIG. 29 if the sampling pulse's width equals a “bit” width 161, and the sampling periods are contiguous there is always an overlap of greater than 50% between the two intervals 160, 163. Of course if the leading edges of the two periods may be synchronized a 100% overlap may be achieved. Therefore a criterion may be adopted that signals above 50% of the expected maximum will be viewed as (1) and signals of less than 50% as (0). Thus one can see that in all the 3 exhaustive possibilites, when the sampling beam lags by less than 50% 173, when the sampling beam lags by more than 50% 177 and when the sampling beam is just in time 175, a data train (101001101) 172 sampled randomly, always results in one overlap of more than 50% and allows a correct reading as can be seen from the readings 174, 176 and 178. The error rate that may occur in borderline cases of 51% vs 49% may be greatly improved by doubling the sampling rate.

There are several ways to accomplish the devices explained above and illustrated in the accompanying figures, without departing from the scope of the present invention. Those skilled in the art will recognize that other configurations are possible. It will thus be seen that the invention efficiently attains the objects set forth above, among those made apparent from the preceding description. While the invention has been described with respect to the preferred embodiments thereof, it will be understood by those skilled in the art that changes may be made in the above construction and in the foregoing sequences of operation without departing from the scope and spirit of the invention. It is accordingly intended that all matter contained in the above description or shown in the accompanying figures be interpreted as illustrative rather than in a limiting sense.

Many variations and modifications may be made to the various embodiments of the present invention without departing substantially from the spirit and principles of the invention. All such modifications and variations are intended to be included herein within the scope of the present invention, as defmed by the claims.

I claim:

1. A sequence of interconnected, 2 input (A and B), 2 output (C and D), Gᵢ sampling gates, (i=1 . . . n) defined by the table

| A | B | C | D |
|---|---|---|---|
| 0 | 0 | 0 | 0 |
| 0 | 1 | 0 | 0 |
| 1 | 0 | 0 | 1 |
| 1 | 1 | 1 | 0 |

for sampling an electromagnetic wave, wherein the output Dᵢ (i=1 . . . n−1) of each sampling gate, after being delayed by Tᵢ=(Δtᵢ+tᵢ)(i=1 . . . n−1), where (Δtᵢ) is the time delay within the sampling gate and tᵢ is the delay between the output Dᵢ of a sampling gate (i) and the input Aᵢ₊₁ of the successive gate G₍ᵢ₊₁₎, is fed to the input Aᵢ₊₁ (i=1 . . . n) of the following sampling gate, and wherein the sampling inputs Bᵢ (i=1 . . . n) are applied to all the interconnected (n) sampling gates simultaneously for a sampling period τᵢ, synchronized with the electromagnetic wave fed at input Aᵢ, leading to the simultaneous appearance of all the outputs Cᵢ for the same period τᵢ, after a time delay (δτᵢ) the length of which depends on the nature of the interaction of the electromagnetic wave with the matter of which the sampling gate (i) is made,

2. A sequence of interconnected, Gᵢ sampling gates according to claim 1 wherein the intensity level of the outputs Cᵢ of the sampling gates Gᵢ is proportional to the intensity levels of inputs at Aᵢ and Bᵢ

3. A sequence of interconnected, Gᵢ sampling gates according to claim 1 wherein the sampling inputs Bᵢ are derived from a common source I synchronized with the electromagnetic wave applied to input A₁ and are delayed each by Tᵢ [n−(i−1)] for (i=1 . . . n) before applying them to the sampling gates inputs Bᵢ for sampling the inputs Aᵢ,

4. A sequence of interconnected, Gᵢ sampling gates according to claim 1 wherein the sampled electromagnetic wave is an optical data train of consecutive “one”s and “zero”s and wherein the sampling pulses Bᵢ all are of the same intensity and their pulsewidths the same as the “one”s and “zero”s of the data train, signal levels above the average level of all the signals measured at the outputs of a sampling gate Cᵢ, are declared as “one”s and signal levels below the average level of all the signals measured at the outputs of a sampling gate Cᵢ, are counted declared as “zero”s.

5. A sequence of interconnected, Gᵢ sampling gates according to claim 1 wherein the sampling inputs Bᵢ are derived from a common source generated by determining the start of the electromagnetic wave with an optical correlator that compares the electromagnetic wave with one or several patterns, triggering a high intensity laser with the output of said correlator, such laser emitting a beam at a lower wavelength than the wavelength of the output of the correlator, such that in a Raman active medium, the wavelength of the output of the correlator is at the First Stokes wavelength of the output of said laser, combining the delayed output of the correlator with the output of the laser in a waveguide that comprises a saturable absorber, a Raman active medium and a filter that has a stop band at the wavelength of said laser beam, and feeding the evenly split (n) outputs of the waveguide for distribution among the (n) Bᵢ inputs of the sampling gates after delaying each input Bᵢ sampling wave by Tᵢ [n−(i−1)] for (i=1 . . . n),

6. A sequence of interconnected, Gᵢ sampling gates according to claim 1 wherein when the sampling time τᵢ is smaller than the propagation time between adjacent sampling gates Tᵢ, the outputs Cᵢ of all the sampling gates Gᵢ (i=1 . . . n) are delayed by (iT_{compress}) where T_{compress}≦Tᵢ−τᵢ and combined into one compressed electromagnetic wave.

7. A sequence of interconnected, Gᵢ sampling gates according to claim 1 wherein the outputs Cᵢ of the sampling gates Gᵢ (i=1 . . . n) are combined serially into one electromagnetic wave after inserting delays of (T_{stretch})ᵢ between any two consecutive sampling gates

8. A sequence of interconnected, Gᵢ sampling gates according to claim 1 wherein the time distance between two consecutive Gates Tᵢ is a multiple of the “bit” length of a modulated electromagnetic wave that contains a data train.

9. A sequence of interconnected, Gᵢ sampling gates according to claim 4 wherein the electromagnetic wave to be sampled is an optical beam, and comprises two transparent plates wherein the sampling gates deposited on the lower plate consist of a highly non-linear multilayer dielectric mirror that while normally being fully reflective, turns transparent by a high intensity sampling beam Bᵢ, transmitted through the upper plate, said dielectric mirror, deposited upon a thin layer of saturable absorber which absorbs low intensity optical beams and is backed by an interference filter that stops the sampling beam Bᵢ, while transmitting the optical beam being sampled, and wherein the optical beam to be sampled advances from one sampling gate to the next by reflection between the dielectric mirror when in the reflective mode and a chirped mirror deposited on the upper plate that reflects it towards the dielectric mirror of the following Sampling Gate.

10. A sequence of interconnected, Gᵢ sampling gates according to claim 4 wherein the electromagnetic wave to be sampled is an optical beam, and comprises a transparent solid block wherein the sampling gates are deposited on the lower face of said block and consist of a of highly non-linear multilayer dielectric mirror, a source of high intensity electromagnetic wave illuminating the dielectric mirror from the side in a direction orthogonal to it, a thin layer of saturable absorber deposited upon said dielectric mirror, and an interference filter that stops the sampling beam Bᵢ, while transmitting the optical beam being sampled deposited on said saturable absorber and a photoelectric detector positioned after the filter, and wherein the optical beam to be sampled advances from one sampling gate to the next by reflection between the dielectric mirror on the lower face when in the reflective mode and a chirped mirror deposited on the upper face that reflects it towards the dielectric mirror of the following Sampling Gate and wherein the Bᵢ sampling beams enter said transparent block from above after traversing the chirped mirror,

11. A sequence of interconnected, Gᵢ sampling gates according to claim 4 wherein the electromagnetic wave to be sampled is an optical beam at a wavelength equal to the first Stokes wavelength of the sampling beam Bᵢ, and comprising two transparent plates wherein the sampling gates deposited on the lower plate consist of a of highly non-linear multilayer dielectric mirror that while normally being fully reflective, turns transparent by the high intensity sampling beam Bᵢ, transmitted through the upper plate, said dielectric mirror, deposited upon a thin layer of saturable absorber which absorbs low intensity optical waves, which in turn is deposited on a thick layer of Raman active crystalline matter and is backed by an interference filter that can stop the sampling beam Bᵢ, while transmitting the optical beam being sampled, and wherein the optical beam to be sampled advances from one sampling gate to the next by reflection between the dielectric mirror when in the reflective mode and a chirped mirror deposited on the upper plate that reflects it towards the dielectric mirror of the following Sampling Gate.

12. A sequence of interconnected, Gᵢ sampling gates according to claim 4 wherein the electromagnetic wave to be sampled is an optical beam, comprising two transparent plates wherein the sampling gates deposited on the lower plate consist of a highly non-linear multilayer dielectric mirror that while normally being fully reflective, turns transparent by the high intensity sampling beam Bᵢ, transmitted through the upper plate, said dielectric mirror, deposited upon a thick layer of Second Generation Harmonic (SGH) material where the optical beam to be sampled and the sampling beam Bᵢ, interact and produce an energy sum beam, and is backed by an interference filter that transmits the sum beam and is detected by a photoelectric detector behind the transparent plate, and wherein the optical beam to be sampled advances from one sampling gate to the next by reflection between the dielectric mirror when reflective and a chirped mirror deposited on the upper plate that reflects it towards the dielectric mirror of the following Sampling Gate.

13. A sequence of interconnected, Gᵢ sampling gates according to claim 4 wherein the electromagnetic wave to be sampled is an optical beam, comprising two transparent plates wherein the sampling gates deposited on the lower plate consist of a highly non-linear multilayer dielectric mirror, said dielectric mirror, deposited upon a semiconductor PIN photodiode, wherein the energies of the sampled and sampling beams are below the bandgap of said semiconductor and their combined energy sum is above such bandgap, and wherein the optical beam to be sampled advances from one sampling gate to the next by reflection between the dielectric mirror and a chirped mirror deposited on the upper plate, and wherein the sampling beam derived from a common source transmitted through the upper plate,

14. A sequence of interconnected, Gᵢ sampling gates according to claim 4 implemented in a Photonic crystal structure, wherein the electromagnetic wave to be sampled is an optical beam that propagates in a first straight waveguide and wherein the sampling beam propagates in a second waveguide which for every Sampling Gate, its route approaches the first waveguide at which place it has a set of connected resonant cavities, evanescently coupled with the first waveguide, and wherein for every Sampling Gate a third waveguide having one end close to the second waveguide at places where the connected resonant cavities are and the second end exiting the photonic crystal, and wherein the sampling beam, is appropriately delayed by a second set of connected resonant cavities before the area where it is evanescently coupled to the first and third waveguides, so that all the Sampling Gates become critically coupled simultaneously,

15. A sequence of interconnected, Gᵢ sampling gates according to claim 1 implemented in a Photonic crystal structure, wherein the electromagnetic wave to be sampled is an optical beam that propagates in a first straight waveguide and wherein the sampling beam propagates in a second waveguide which for every Sampling Gate its route approaches the first waveguide where a micro-ring made of highly non-linear material, evanescently couples the first waveguide with a third waveguide that has its other end exiting the photonic crystal, and wherein the sampling beam is of an intensity that can change the refractive index of said non-linear micro-ring thus critically coupling said first and third waveguides, and wherein the sampling beam, is appropriately delayed by a set of connected resonant cavities before reaching each micro-ring, so that all said micro-rings are illuminated simultaneously,

16. A sequence of interconnected, Gᵢ sampling gates according to claim 1 wherein the sampled electromagnetic wave is electrical and propagates in a coaxial transmission line and wherein for every sampling gate the sampling wave consists of an optical signal that closes an ultrafast photoconducting switch and thus inductively extracts an electrical signal from the transmission line through an inductor wound around the central conductor at a short distance from its center, and wherein the optical pulses activating the photoconducting switches are appropriately delayed so that all the switches will be activated simultaneously

17. A sequence of interconnected, Gᵢ sampling gates according to claim 4 wherein the electromagnetic wave to be sampled is an optical signal propagating in a first optical fiber and the sampling gates consist of a multiplicity of secondary optical fibers having a highly non-linear composition and structure in a section evanescently coupled to said first fiber along a distance equal to the coupling length and wherein the composition and structure of the secondary fibers are so selected that the difference in their propagation constants (β₁−β₂)>0 is such that no power will be transferred along a coupling length, and wherein increasing the propagating constant of the secondary fibers by illuminating the non-linear section of the secondary fibers with a high intensity sampling beam will make the propagation constants of the secondary fibers equal to that of the first fiber, and wherein the secondary fibers having immediately after the highly nonlinear section a long section doped with Raman active crystalline material followed by a section doped with a saturable absorber and a fiber grating filter that stops the wavelength of the high intensity sampling beam

18. A sequence of interconnected, Gᵢ sampling gates according to claim 4 wherein the electromagnetic wave to be sampled is an optical signal propagating in a first optical fiber and the sampling gates consist of a multiplicity of secondary optical fibers having a highly non-linear composition and structure in a section evanescently coupled to said first fiber along a distance equal to the coupling length and wherein the composition and structure of the secondary fibers are so selected that the difference in their propagation constants (β₁−β₂)>0 is such that no power will be transferred along a coupling length, and wherein increasing the propagating constant of the secondary fibers by illuminating the non-linear section of the secondary fibers with a high intensity sampling beam will make the propagation constants of the secondary fibers equal to that of the first fiber, and wherein the secondary fibers having immediately after the highly nonlinear section a long section doped with Raman active crystalline material followed by a section doped with a saturable absorber and a fiber grating filter that stops the wavelength of the high intensity sampling beam and wherein the sampling gates may each transmit simultaneously light pulses coming through an auxiliary fiber coupled to the secondary fiber, which being coupled to the first fiber, result in a sequence of pulses that propagate serially in the first fiber,

19. A sequence of interconnected, Gᵢ sampling gates according to claim 4 wherein the electromagnetic wave to be sampled is an optical signal propagating in a first optical fiber and wherein the sampling gates consist of a multiplicity of secondary optical fibers laying across and above the first fiber, separated by a thin dielectric film and a micro-ring of a highly non-linear composition evanescently coupled to both the first and secondary fibers along their axis and wherein the intensity of the sampling beam is such that it can change the resonant frequency of the non-linear micro-ring and thereby achieve critical coupling and transfer of the beam from the first to the secondary fibers for the duration of the sampling beam
